(19) United States
(12) Patent Application Publication
(10) Pub. No.: US 2008/0220861 A1
(43) Pub. Date: Sep. 11, 2008

(54) GAME SYSTEM INCLUDING SLOT MACHINES AND GAME CONTROL METHOD THEREOF

(75) Inventor: Kazuo OKADA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/938,543

(22) Filed: Nov. 12, 2007

Related U.S. Application Data
(60) Provisional application No. 60/905,070, filed on Mar. 6, 2007.

(51) Int. Cl. A63F 13/00

(52) U.S. Cl. 463/31

(57) ABSTRACT

A gaming machine is provided with a controller which displays on a display a predetermined number of card images every time a mini game is executed; if card image identification data are received before an elapse of a predetermined time, perform processing to display the received card image, depending on the received card image identification data, by replacing the displayed predetermined number of card images; unless the card image identification data are received before the elapse of the predetermined time, displays intactly the displayed predetermined number of card images; decides whether to update the accumulative point number, depending on a combination of the displayed card images; and decides the number of times of a free game, depending on an accumulative point number updated after the mini game is executed a predetermined number of times.

### BACKGROUND OF THE INVENTION

1. Field of the Invention

The present invention relates to a gaming machine that changes the number of free games depending on the outcome of a card game, to which a player can perform input operation.

2. Related Art

Previously, it has been known that some of slot machines transit, if a predetermined condition is met in a basic game, to a game state, being called “free game” where a predetermined game can be played without reducing the amount of credits. The transition to the free game state enables a player to have a chance of gaining many credits. For example, AU2000PQ6296 discloses a free game as a second game. In general, the number of times of the free game can be decided at random, or alternatively a certain number of times of the free game can be set.

The present invention provides a gaming machine with new entertainment properties.

### SUMMARY OF THE INVENTION

A first aspect of the present invention is directed to a gaming machine which includes: a display for displaying an image; memory for storing an accumulative point number to be updated depending on an outcome of a mini game, and a plurality of types of point numbers corresponding to a plurality of types of card image combinations, respectively; a first input device for outputting card image identification data identifying a card image a player selects from a plurality of card images displayed on the display; a second input device for outputting a signal that starts a basic game; and a controller operable to: (a) start the basic game in response to a receipt of the signal from the second input device; (b) execute the mini game provided that the basic game has commenced; (c) display on the display a predetermined number of card images every time the mini game is executed; (d) if the card image identification data are received before an elapse of a predetermined time from a start of execution of the mini game, perform processing to display the received card image, depending on the received card image identification data, by replacing the displayed predetermined number of card images; (e) unless the card image identification data are received before the elapse of the predetermined time, display intactly the displayed predetermined number of card images; (f) decide whether to update the accumulative point number, depending on a combination of the displayed card images; (g) if a decision is made to update, update the accumulative point number by adding a point number based on the combination to the accumulative point number; (h) decide a number of times of a free game, depending on an accumulative point number updated after the mini game is executed a predetermined number of times; and (i) provided that a predetermined condition is met, make a transition from the basic game to the free game, and execute the free game by the decided number of times.

The gaming machine of the first aspect is adapted to (a) start a basic game in response to a receipt of a signal from a second input device, (b) execute a mini game provided that the basic game has commenced, (c) display on a display a predetermined number of card images every time the mini game is executed, (d) if card image identification data are received before an elapse of a predetermined time from a start of execution of the mini game, perform processing to display the received card image, depending on the received card image identification data, by replacing the displayed predetermined number of card images, (e) unless card image identification data are received before the elapse of the predetermined time, display intactly the displayed predetermined number of card images, (f) decide whether to update an accumulative point number, depending on a combination of the displayed card images, (g) if a decision is made to update, update the accumulative point number by adding a point number based on the combination to the accumulative point number, (h) decide a number of times of a free game, depending on an accumulative point number updated after the mini game is executed a predetermined number of times, and (i) provided that a predetermined condition is met, make a transition from the basic game to the free game, and execute the free game by the decided number of times.

A second aspect of the present invention is directed to a gaming machine which includes: a display for displaying an image; memory for storing an accumulative point number to be updated depending on an outcome of a mini game, and a plurality of types of point numbers corresponding to a plurality of types of card image combinations, respectively; a first input device for outputting card image identification data identifying a card image a player selects from a plurality of card images displayed on the display; a second input device for outputting a signal that starts a basic game; and a controller operable to: (a) start the basic game in response to a receipt of the signal from the second input device; (b) execute the mini game provided that the basic game has commenced; (c) display on the display a predetermined number of card images every time the mini game is executed; (d) if the card image identification data are received before an elapse of a predetermined time from a start of execution of the mini game, perform processing to display the received card image, depending on the received card image identification data, by replacing the displayed predetermined number of card images; (e) unless the card image identification data are received before the elapse of the predetermined time, display intactly the displayed predetermined number of card images; (f) decide whether to update the accumulative point number, depending on a combination of the displayed card images; (g) if a decision is made to update, update the accumulative point number by adding a point number based on the combination to the accumulative point number; (h) display the updated accumulative point number; (i) decide a number of times of a free game, depending on an accumulative point number updated after the mini game is executed a predetermined number of times; and (j) provided that a predetermined condition is met, make a transition from the basic game to the free game, and execute the free game by the decided number of times.

The gaming machine of the second aspect is adapted to (a) start a basic game in response to a receipt of a signal from a second input device, (b) execute a mini game provided that the basic game has commenced, (c) display on a display a predetermined number of card images every time the mini game is executed, (d) if card image identification data are received before an elapse of a predetermined time from a start of execution of the mini game, perform processing to display the received card image, depending on the received card image identification data, by replacing the displayed predetermined number of card images, (e) unless card image identification data are received before the elapse of the predetermined time, display intactly the displayed predetermined number of card images, (f) decide whether to update an accumulative point number, depending on a combination of the displayed card images, (g) if a decision is made to update, update the accumulative point number by adding a point number based on the combination to the accumulative point number, (h) display the updated accumulative point number, (i) decide a number of times of a free game, depending on an accumulative point number updated after the mini game is executed a predetermined number of times, and (j) provided that a predetermined condition is met, make a transition from the basic game to the free game, and execute the free game by the decided number of times.

A third aspect of the present invention is directed to a gaming machine which includes: a display for displaying an image; memory for storing an accumulative point number to be updated depending on an outcome of a mini game, and a plurality of types of point numbers corresponding to a plurality of types of card image combinations, respectively; a first input device for outputting card image identification data identifying a card image a player selects from a plurality of card images displayed on the display; a second input device for outputting a signal that starts a basic game; and a controller operable to: (a) start the basic game in response to a receipt of the signal from the second input device; (b) execute the mini game provided that the basic game has commenced; (c) display on the display a predetermined number of card images every time the mini game is executed; (d) if the card image identification data are received before an elapse of a predetermined time from a start of execution of the mini game, perform processing to display the received card image, depending on the received card image identification data, by replacing the displayed predetermined number of card images; (e) unless the card image identification data are received before the elapse of the predetermined time, display intactly the displayed predetermined number of card images; (f) decide whether to update the accumulative point number, depending on a combination of the displayed card images; (g) if a decision is made to update, update the accumulative point number by adding a point number based on the combination to the accumulative point number; (h) display the updated accumulative point number and a predetermined clear point number; (i) if an accumulative point number updated after the mini game is executed a predetermined number of times is at least the predetermined clear point number, decide a number of times of a free game, depending on the updated accumulative point number; and (j) provided that a predetermined condition is met, make a transition from the basic game to the free game, and execute the free game by the decided number of times.

The gaming machine of the third aspect is adapted to (a) start a basic game in response to a receipt of a signal from a second input device, (b) execute a mini game provided that the basic game has commenced, (c) display on a display a predetermined number of card images every time the mini game is executed, (d) if card image identification data are received before an elapse of a predetermined time from a start of execution of the mini game, perform processing to display the received card image, depending on the received card image identification data, by replacing the displayed predetermined number of card images, (e) unless the card image identification data are received before the elapse of the predetermined time, display intactly the displayed predetermined number of card images, (f) decide whether to update an accumulative point number, depending on a combination of the displayed card images, (g) if a decision is made to update, update the accumulative point number by adding a point number based on the combination to the accumulative point number, (h) display the updated accumulative point number and a predetermined clear point number, (i) if an accumulative point number updated after the mini game is executed a predetermined number of times is at least the predetermined clear point number, decide a number of times of a free game, depending on the updated accumulative point number, and (j) provided that a predetermined condition is met, make a transition from the basic game to the free game, and execute the free game by the decided number of times.

A fourth aspect of the present invention is directed to a gaming machine which includes: a display for displaying an image; memory for storing an accumulative point number to be updated depending on an outcome of a mini game, and a plurality of types of point numbers corresponding to a plurality of types of card image combinations, respectively; a first input device for outputting card image identification data identifying a card image a player selects from a plurality of card images displayed on the display; a second input device for outputting a signal that starts a basic game; and a controller operable to: (a) start the basic game in response to a receipt of the signal from the second input device; (b) execute the mini game provided that the basic game has commenced; (c) display on the display a predetermined number of card images every time the mini game is executed; (d) if the card image identification data are received before an elapse of a predetermined time from a start of execution of the mini game, perform processing to display the received card image, depending on the received card image identification data, by replacing the displayed predetermined number of card images; (e) unless the card image identification data are received before the elapse of the predetermined time, display intactly the displayed predetermined number of card images; (f) decide whether to update the accumulative point number, depending on a combination of the displayed card images; (g) if a decision is made to update, update the accumulative point number by adding a point number based on the combination to the accumulative point number; (h) display the updated accumulative point number and a predetermined clear point number; (i) if an accumulative point number updated after the mini game is executed a predetermined number of times is at least the predetermined clear point number, decide a number of times of a free game, depending on the updated accumulative point number and the predetermined clear point number; and (j) provided that a predetermined condition is met, make a transition from the basic game to the free game, and execute the free game by the decided number of times.

The gaming machine of the fourth aspect is adapted to (a) start a basic game in response to a receipt of a signal from a second input device, (b) execute a mini game provided that the basic game has commenced, (c) display on a display a predetermined number of card images every time the mini game is executed, (d) if card image identification data are received before an elapse of a predetermined time from a start of execution of the mini game, perform processing to display the received card image, depending on the received card image identification data, by replacing the displayed predetermined number of card images, (e) unless card image identification data are received before the elapse of the predetermined time, display intactly the displayed predetermined number of card images, (f) decide whether to update an accumulative point number, depending on a combination of the displayed card images, (g) if a decision is made to update, update the accumulative point number by adding a point number based on the combination to the accumulative point number, (h) display the updated accumulative point number and a predetermined clear point number, (i) if an accumulative point number updated after the mini game is executed a predetermined number of times is at least the predetermined clear point number, decide a number of times of a free game, depending on the updated accumulative point number and the predetermined clear point number, and (j) provided that a predetermined condition is met, make a transition from the basic game to the free game, and execute the free game by the decided number of times.

A fifth aspect of the present invention is directed to a gaming machine which includes: a display for displaying an image; memory for storing an accumulative point number to be updated depending on an outcome of a mini game, and a plurality of types of point numbers corresponding to a plurality of types of card image combinations, respectively; a first input device for outputting card image identification data identifying a card image a player selects from a plurality of card images displayed on the display; a second input device for outputting a signal that starts a basic game; and a controller operable to: (a) start the basic game in response to a receipt of the signal from the second input device; (b) provided that the basic game has commenced, execute the mini game every time the basic game is executed; (c) display on the display a predetermined number of card images every time the mini game is executed; (d) if the card image identification data are received before an elapse of a predetermined time from a start of execution of the mini game, perform processing to display the received card image, depending on the received card image identification data, by replacing the displayed predetermined number of card images; (e) unless the card image identification data are received before the elapse of the predetermined time, display intactly the displayed predetermined number of card images; (f) decide whether to update the accumulative point number, depending on a combination of the displayed card images; (g) if a decision is made to update, update the accumulative point number by adding a point number based on the combination to the accumulative point number; (h) decide a number of times of a free game, depending on an accumulative point number updated after the mini game is executed a predetermined number of times; and (i) provided that a predetermined condition is met, make a transition from the basic game to the free game, and execute the free game by the decided number of times.

The gaming machine of the fifth aspect is adapted to (a) start a basic game in response to a receipt of a signal from a second input device, (b) provided that the basic game has commenced, execute a mini game every time the basic game is executed, (c) display on a display a predetermined number of card images every time the mini game is executed, (d) if card image identification data are received before an elapse of a predetermined time from a start of execution of the mini game, perform processing to display the received card image, depending on the received card image identification data, by replacing the displayed predetermined number of card images, (e) unless card image identification data are received before the elapse of the predetermined time, display intactly the displayed predetermined number of card images, (f) decide whether to update an accumulative point number, depending on a combination of the displayed card images, (g) if a decision is made to update, update the accumulative point number by adding a point number based on the combination to the accumulative point number, (h) decide a number of times of a free game, depending on an accumulative point number updated after the mini game is executed a predetermined number of times, and (i) provided that a predetermined condition is met, make a transition from the basic game to the free game, and execute the free game by the decided number of times.

A sixth aspect of the present invention is directed to a gaming machine which includes: a display for displaying an image; memory for storing an accumulative point number to be updated depending on an outcome of a mini game, and a plurality of types of point numbers corresponding to a plurality of types of card image combinations, respectively; a first input device for outputting card image identification data identifying a card image a player selects from a plurality of card images displayed on the display; a second input device for outputting a signal that starts a basic game; and a controller operable to: (a) start the basic game in response to a receipt of the signal from the second input device; (b) provided that the basic game has commenced, execute the mini game every time the basic game is executed; (c) display on the display a predetermined number of card images every time the mini game is executed; (d) if the card image identification data are received before an elapse of a predetermined time from a start of execution of the mini game, perform processing to display the received card image, depending on the received card image identification data, by replacing the displayed predetermined number of card images; (e) unless the card image identification data are received before the elapse of the predetermined time, display intactly the displayed predetermined number of card images; (f) decide whether to update the accumulative point number, depending on a combination of the displayed card images; (g) if a decision is made to update, update the accumulative point number by adding a point number based on the combination to the accumulative point number; (h) display the updated accumulative point number; (i) decide a number of times of a free game, depending on an accumulative point number updated after the mini game is executed a predetermined number of times; and (j) provided that a predetermined condition is met, make a transition from the basic game to the free game, and execute the free game by the decided number of times.

The gaming machine of the sixth aspect is adapted to (a) start a basic game in response to a receipt of a signal from a second input device, (b) provided that the basic game has commenced, execute a mini game every time the basic game is executed, (c) display on a display a predetermined number of card images every time the mini game is executed, (d) if card image identification data are received before an elapse of a predetermined time from a start of execution of the mini game, perform processing to display the received card image, depending on the received card image identification data, by replacing the displayed predetermined number of card images, (e) unless card image identification data are received before the elapse of the predetermined time, display intactly the displayed predetermined number of card images, (f) decide whether to update an accumulative point number, depending on a combination of the displayed card images, (g) if a decision is made to update, update the accumulative point number by adding a point number based on the combination to the accumulative point number, (h) display the updated accumulative point number, (i) decide a number of times of a free game, depending on an accumulative point number updated after the mini game is executed a predetermined number of times; and (j) provided that a predetermined condition is met, make a transition from the basic game to the free game, and execute the free game by the decided number of times.

A seventh aspect of the present invention is directed to a gaming machine which includes: a display for displaying an image; memory for storing an accumulative point number to be updated depending on an outcome of a mini game, and a plurality of types of point numbers corresponding to a plurality of types of card image combinations, respectively; a first input device for outputting card image identification data identifying a card image a player selects from a plurality of card images displayed on the display; a second input device for outputting a signal that starts a basic game; and a controller operable to: (a) start the basic game in response to a receipt of the signal from the second input device; (b) provided that the basic game has commenced, execute the mini game every time the basic game is executed; (c) display on the display a predetermined number of card images every time the mini game is executed; (d) if the card image identification data are received before an elapse of a predetermined time from a start of execution of the mini game, perform processing to display the received card image, depending on the received card image identification data, by replacing the displayed predetermined number of card images; (e) unless the card image identification data are received before the elapse of the predetermined time, display intactly the displayed predetermined number of card images; (f) decide whether to update the accumulative point number, depending on a combination of the displayed card images; (g) if a decision is made to update, update the accumulative point number by adding a point number based on the combination to the accumulative point number; (h) display the updated accumulative point number and a predetermined clear point number; (i) if an accumulative point number updated after the mini game is executed a predetermined number of times is at least the predetermined clear point number, decide a number of times of a free game, depending on the updated accumulative point number; and (j) provided that a predetermined condition is met, make a transition from the basic game to the free game, and execute the free game by the decided number of times.

The gaming machine of the seventh aspect is adapted to (a) start a basic game in response to a receipt of a signal from a second input device, (b) provided that the basic game has commenced, execute a mini game every time the basic game is executed, (c) display on a display a predetermined number of card images every time the mini game is executed, (d) if card image identification data are received before an elapse of a predetermined time from a start of execution of the mini game, perform processing to display the received card image, depending on the received card image identification data, by replacing the displayed predetermined number of card images, (e) unless card image identification data are received before the elapse of the predetermined time, display intactly the displayed predetermined number of card images, (f) decide whether to update an accumulative point number, depending on a combination of the displayed card images, (g) if a decision is made to update, update the accumulative point number by adding a point number based on the combination to the accumulative point number, (h) display the updated accumulative point number and a predetermined clear point number, (i) if an accumulative point number updated after the mini game is executed a predetermined number of times is at least the predetermined clear point number, decide a number of times of a free game, depending on the updated accumulative point number, and (j) provided that a predetermined condition is met, make a transition from the basic game to the free game, and execute the free game by the decided number of times.

An eighth aspect of the present invention is directed to a gaming machine which includes: a display for displaying an image; memory for storing an accumulative point number to be updated depending on an outcome of a mini game, and a plurality of types of point numbers corresponding to a plurality of types of card image combinations, respectively; a first input device for outputting card image identification data identifying a card image a player selects from a plurality of card images displayed on the display; a second input device for outputting a signal that starts a basic game; and a controller operable to: (a) start the basic game in response to a receipt of the signal from the second input device; (b) provided that the basic game has commenced, execute the mini game every time the basic game is executed; (c) display on the display a predetermined number of card images every time the mini game is executed; (d) if the card image identification data are received before an elapse of a predetermined time from a start of execution of the mini game, perform processing to display the received card image, depending on the received card image identification data, by replacing the displayed predetermined number of card images; (e) unless the card image identification data are received before the elapse of the predetermined time, display intactly the displayed predetermined number of card images; (f) decide whether to update the accumulative point number, depending on a combination of the displayed card images; (g) if a decision is made to update, update the accumulative point number by adding a point number based on the combination to the accumulative point number; (h) display the updated accumulative point number and a predetermined clear point number; (i) if an accumulative point number updated after the mini game is executed a predetermined number of times is at least the predetermined clear point number, decide a number of times of a free game, depending on the updated accumulative point number and the predetermined clear point number; and (j) provided that a predetermined condition is met, make a transition from the basic game to the free game, and execute the free game by the decided number of times.

The gaming machine of the eighth aspect is adapted to (a) start a basic game in response to a receipt of a signal from a second input device, (b) provided that the basic game has commenced, execute a mini game every time the basic game is executed, (c) display on a display a predetermined number of card images every time the mini game is executed, (d) if card image identification data are received before an elapse of a predetermined time from a start of execution of the mini game, perform processing to display the received card image, depending on the received card image identification data, by replacing the displayed predetermined number of card images, (e) unless card image identification data are received before the elapse of the predetermined time, display intactly the displayed predetermined number of card images, (f) decide whether to update an accumulative point number, depending on a combination of the displayed card images, (g) if a decision is made to update, update the accumulative point number by adding a point number based on the combination to the accumulative point number, (h) display the updated accumulative point number and a predetermined clear point number, (i) if an accumulative point number updated after the mini game is executed a predetermined number of times is at least the predetermined clear point number, decide a number of times of a free game, depending on the updated accumulative point number and the predetermined clear point number, and (j) provided that a predetermined condition is met, make a transition from the basic game to the free game, and execute the free game by the decided number of times.

A ninth aspect of the present invention is directed to a gaming machine which includes: a display for displaying an image; memory for storing an accumulative point number to be updated depending on an outcome of a mini game, and a plurality of types of point numbers corresponding to a plurality of types of card image combinations, respectively; a first input device for outputting card image identification data identifying a card image a player selects from a plurality of card images displayed on the display; a second input device for outputting a signal that starts a basic game; and a controller operable to: (a) start the basic game in response to a receipt of the signal from the second input device; (b) provided that a predetermined condition is met, make a transition to a special game state where the mini game is repetitively executed a predetermined number of times; (c) execute the mini game upon completion of the transition to the special game state; (d) display on the display a predetermined number of card images every time the mini game is executed; (e) if the card image identification data are received before an elapse of a predetermined time from a start of execution of the mini game, perform processing to display the received card image, depending on the received card image identification data, by replacing the displayed predetermined number of card images; (f) unless the card image identification data are received before the elapse of the predetermined time, display intactly the displayed predetermined number of card images; (g) decide whether to update the accumulative point number, depending on a combination of the displayed card images; (h) if a decision is made to update, update the accumulative point number by adding a point number based on the combination to the accumulative point number; (i) decide a number of times of a free game, depending on an accumulative point number updated after the mini game is executed a predetermined number of times; and (j) provided that a different condition from the predetermined condition is met, make a transition from the basic game to the free game, and execute the free game by the decided number of times.

The gaming machine of the ninth aspect is adapted to (a) start a basic game in response to a receipt of a signal from a second input device, (b) provided that a predetermined condition is met, make a transition to a special game state where a mini game is repetitively executed a predetermined number of times, (c) execute the mini game upon completion of the transition to the special game state, (d) display on a display a predetermined number of card images every time the mini game is executed, (e) if card image identification data are received before an elapse of a predetermined time from a start of execution of the mini game, perform processing to display the received card image, depending on the received card image identification data, by replacing the displayed predetermined number of card images, (f) unless card image identification data are received before the elapse of the predetermined time, display intactly the displayed predetermined number of card images, (g) decide whether to update an accumulative point number, depending on a combination of the displayed card images, (h) if a decision is made to update, update the accumulative point number by adding a point number based on the combination to the accumulative point number, (i) decide a number of times of a free game, depending on an accumulative point number updated after the mini game is executed a predetermined number of times, and (j) provided that a different condition from the predetermined condition is met, make a transition from the basic game to the free game, and execute the free game by the decided number of times.

A tenth aspect of the present invention is directed to a gaming machine which includes: a display for displaying an image; memory for storing an accumulative point number to be updated depending on an outcome of a mini game, and a plurality of types of point numbers corresponding to a plurality of types of card image combinations, respectively; a first input device for outputting card image identification data identifying a card image a player selects from a plurality of card images displayed on the display; a second input device for outputting a signal that starts a basic game; and a controller operable to: (a) start the basic game in response to a receipt of the signal from the second input device; (b) provided that a predetermined condition is met, make a transition to a special game state where the mini game is repetitively executed a predetermined number of times; (c) execute the mini game upon completion of the transition to the special game state; (d) display on the display a predetermined number of card images every time the mini game is executed; (e) if the card image identification data are received before an elapse of a predetermined time from a start of execution of the mini game, perform processing to display the received card image, depending on the received card image identification data, by replacing the displayed predetermined number of card images; (f) unless the card image identification data are received before the elapse of the predetermined time, display intactly the displayed predetermined number of card images; (g) decide whether to update the accumulative point number, depending on a combination of the displayed card images; (h) if a decision is made to update, update the accumulative point number by adding a point number based on the combination to the accumulative point number; (i) display the updated accumulative point number; (j) decide a number of times of a free game, depending on an accumulative point number updated after the mini game is executed a predetermined number of times; and (k) provided that a different condition from the predetermined condition is met, make a transition from the basic game to the free game, and execute the free game by the decided number of times.

The gaming machine of the tenth aspect is adapted to (a) start a basic game in response to a receipt of a signal from a second input device, (b) provided that a predetermined condition is met, make a transition to a special game state where a mini game is repetitively executed a predetermined number of times, (c) execute the mini game upon completion of the transition to the special game state, (d) display on a display a predetermined number of card images every time the mini game is executed, (e) if card image identification data are received before an elapse of a predetermined time from a start of execution of the mini game, perform processing to display the received card image, depending on the received card image identification data, by replacing the displayed predetermined number of card images, (f) unless card image identification data are received before the elapse of the predetermined time, display intactly the displayed predetermined number of card images, (g) decide whether to update an accumulative point number, depending on a combination of the displayed card images; (h) if a decision is made to update, update the accumulative point number by adding a point number based on the combination to the accumulative point number, (i) display the updated accumulative point number, (j) decide a number of times of a free game, depending on an accumulative point number updated after the mini game is executed a predetermined number of times; and (k) provided that a different condition from the predetermined condition is met, make a transition from the basic game to the free game, and execute the free game by the decided number of times.

An eleventh aspect of the present invention is directed to a gaming machine which includes: a display for displaying an image; memory for storing an accumulative point number to be updated depending on an outcome of a mini game, and a plurality of types of point numbers corresponding to a plurality of types of card image combinations, respectively; a first input device for outputting card image identification data identifying a card image a player selects from a plurality of card images displayed on the display; a second input device for outputting a signal that starts a basic game; and a controller operable to: (a) start the basic game in response to a receipt of the signal from the second input device; (b) provided that a predetermined condition is met, make a transition to a special game state where the mini game is repetitively executed a predetermined number of times; (c) execute the mini game upon completion of the transition to the special game state; (d) display on the display a predetermined number of card images every time the mini game is executed; (e) if the card image identification data are received before an elapse of a predetermined time from a start of execution of the mini game, perform processing to display the received card image, depending on the received card image identification data, by replacing the displayed predetermined number of card images; (f) unless the card image identification data are received before the elapse of the predetermined time, display intactly the displayed predetermined number of card images; (g) decide whether to update the accumulative point number, depending on a combination of the displayed card images; (h) if a decision is made to update, update the accumulative point number by adding a point number based on the combination to the accumulative point number; (i) display the updated accumulative point number and a predetermined clear point number; (j) if an accumulative point number updated after the mini game is executed a predetermined number of times is at least the predetermined clear point number, decide a number of times of a free game, depending on the updated accumulative point number; and (k) provided that a different condition from the predetermined condition is met, make a transition from the basic game to the free game, and execute the free game by the decided number of times.

The gaming machine of the eleventh aspect is adapted to (a) start a basic game in response to a receipt of a signal from a second input device, (b) provided that a predetermined condition is met, make a transition to a special game state where a mini game is repetitively executed a predetermined number of times, (c) execute the mini game upon completion of the transition to the special game state, (d) display on a display a predetermined number of card images every time the mini game is executed, (e) if card image identification data are received before an elapse of a predetermined time from a start of execution of the mini game, perform processing to display the received card image, depending on the received card image identification data, by replacing the displayed predetermined number of card images, (f) unless card image identification data are received before the elapse of the predetermined time, display intactly the displayed predetermined number of card images, (g) decide whether to update an accumulative point number, depending on a combination of the displayed card images, (h) if a decision is made to update, update the accumulative point number by adding a point number based on the combination to the accumulative point number, (i) display the updated accumulative point number and a predetermined clear point number, (j) if an accumulative point number updated after the mini game is executed a predetermined number of times is at least the predetermined clear point number, decide a number of times of a free game, depending on the updated accumulative point number, and (k) provided that a different condition from the predetermined condition is met, make a transition from the basic game to the free game, and execute the free game by the decided number of times.

A twelfth aspect of the present invention is directed to a gaming machine which includes: a display for displaying an image; memory for storing an accumulative point number to be updated depending on an outcome of a mini game, and a plurality of types of point numbers corresponding to a plurality of types of card image combinations, respectively; a first input device for outputting card image identification data identifying a card image a player selects from a plurality of card images displayed on the display; a second input device for outputting a signal that starts a basic game; and a controller operable to: (a) start the basic game in response to a receipt of the signal from the second input device; (b) provided that a predetermined condition is met, make a transition to a special game state where the mini game is repetitively executed a predetermined number of times; (c) execute the mini game upon completion of the transition to the special game state; (d) display on the display a predetermined number of card images every time the mini game is executed; (e) if the card image identification data are received before an elapse of a predetermined time from a start of execution of the mini game, perform processing to display the received card image, depending on the received card image identification data, by replacing the displayed predetermined number of card images; (f) unless the card image identification data are received before the elapse of the predetermined time, display intactly the displayed predetermined number of card images; (g) decide whether to update the accumulative point number, depending on a combination of the displayed card images; (h) if a decision is made to update, update the accumulative point number by adding a point number based on the combination to the accumulative point number; (i) display the updated accumulative point number and a predetermined clear point number; (j) if an accumulative point number updated after the mini game is executed a predetermined number of times is at least the predetermined clear point number, decide a number of times of a free game, depending on the updated accumulative point number and the predetermined clear point number; and (k) provided that a different condition from the predetermined condition is met, make a transition from the basic game to the free game, and execute the free game by the decided number of times.

The gaming machine of the twelfth aspect is adapted to (a) start a basic game in response to a receipt of a signal from a second input device, (b) provided that a predetermined condition is met, make a transition to a special game state where a mini game is repetitively executed a predetermined number of times, (c) execute the mini game upon completion of the transition to the special game state, (d) display on a display a predetermined number of card images every time the mini game is executed, (e) if card image identification data are received before an elapse of a predetermined time from a start of execution of the mini game, perform processing to display the received card image, depending on the received card image identification data, by replacing the displayed predetermined number of card images, (f) unless card image identification data are received before the elapse of the predetermined time, display intactly the displayed predetermined number of card images, (g) decide whether to update an accumulative point number, depending on a combination of the displayed card images, (h) if a decision is made to update, update the accumulative point number by adding a point number based on the combination to the accumulative point number, (i) display the updated accumulative point number and a predetermined clear point number, (j) if an accumulative point number updated after the mini game is executed a predetermined number of times is at least the predetermined clear point number, decide a number of times of a free game, depending on the updated accumulative point number and the predetermined clear point number, and (k) provided that a different condition from the predetermined condition is met, make a transition from the basic game to the free game, and execute the free game by the decided number of times.

### BRIEF DESCRIPTION OF THE DRAWINGS

FIG. 1 is a flow chart showing the flow of a game executed in a gaming machine according to an embodiment of the present invention;

FIG. 2 is a perspective view showing the appearance of the gaming machine according to the embodiment;

FIG. 3 is an enlarged front view showing a display area of the gaming machine according to the embodiment;

FIG. 4 is a block diagram of a controller of the gaming machine according to the embodiment;

FIG. 5 is a block diagram of a display/input controller of the gaming machine according to the embodiment;

FIG. 6 is a diagram showing columns of symbols displayed on the respective image reels of the gaming machine according to the embodiment;

FIG. 7 is a diagram showing a symbol layout table according to the embodiment;

FIGS. 8A and 8B show the flow chart of a basic game processing executed in the gaming machine according to the embodiment;

FIGS. 9A and 9B show the flow chart of a mini game processing executed in the gaming machine according to the embodiment;

FIG. 10 is the flow chart of a free game processing executed in the gaming machine according to the embodiment;

FIG. 11 is a diagram showing a random number table for the basic game according to the embodiment;

FIG. 12 is a diagram showing a random number table for porker role decision according to the embodiment;

FIG. 13 is a diagram showing a point number table according to the embodiment;

FIG. 14 is a diagram showing a free game number table according to the embodiment; and

FIGS. 15 to 19 are examples of the display screens in the mini game executed in the gaming machine according to the embodiment.

### DETAILED DESCRIPTION OF THE INVENTION

An embodiment of the present invention will be described below with reference to the accompanying drawings.

A gaming machine 13 according to the present invention has a liquid crystal display 30 for displaying images, a RAM 110 that stores the accumulative point number to be updated depending on the outcome of a mini game, and a plurality of types of point numbers corresponding to a plurality of types of card image combinations, respectively, and a start switch 25 for outputting a signal that starts a basic game. A CPU 106 starts the basic game in response to a receipt of the signal from the start switch 25, and executes a mini game provided that the basic game has commenced. The CPU 106 then displays, on the display 30, a predetermined number of card images every time the mini game is executed. If card image identification data are received before an elapse of a predetermined time from the start of execution of the mini game, the CPU 106 performs processing to display the received card image, depending on the received card image identification data, by replacing the displayed predetermined number of card images. Unless card image identification data are received before the elapse of the predetermined time, the CPU 106 displays intactly the displayed predetermined number of card images. The CPU 106 then decides whether to update an accumulative point number, depending on a combination of the displayed card images, and if a decision is made to update, it updates the accumulative point number by adding a point number based on the combination to the accumulative point number. The CPU 106 then decides the number of times of a free game, depending on an accumulative point number updated after the mini game is executed a predetermined number of times. Provided that a predetermined condition is met, the CPU 106 makes a transition from the basic game to the free game, and executes the free game by the decided number of times.

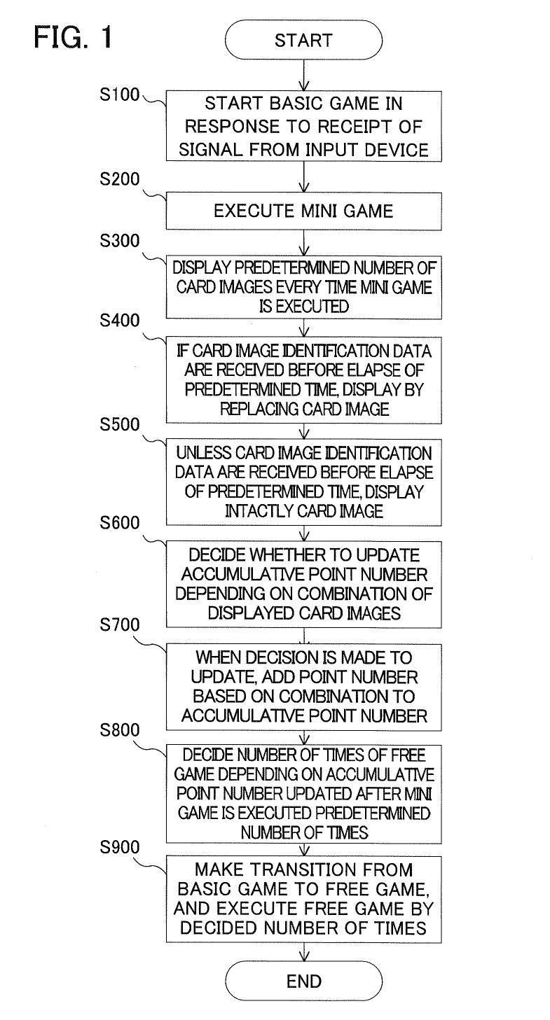

Although the details will be described later, as shown in FIG. 1, the CPU 106 starts the basic game in response to a receipt of the signal from the start switch 25 (step S100), and executes the mini game provided that the basic game has commenced (step S200). The CPU 106 then displays, on the display 30, a predetermined number of card images every time the mini game is executed (step S300). If card image identification data are received before an elapse of a predetermined time from the start of execution of the mini game, the CPU 106 performs processing to display the received card image, depending on the received card image identification data (step S400), by replacing the displayed predetermined number of card images. Unless card image identification data are received before the elapse of the predetermined time, the CPU 106 displays intactly the displayed predetermined number of card images (step S500). The CPU 106 then decides whether to update an accumulative point number, depending on a combination of the displayed card images (step S600), and if a decision is made to update, it updates the accumulative point number by adding a point number based on the combination to the accumulative point number (step S700). The CPU 106 then decides the number of times of a free game, depending on an accumulative point number updated after the mini game is executed a predetermined number of times (step S800). Provided that a predetermined condition is met, the CPU 106 makes a transition from the basic game to the free game, and executes the free game by the decided number of times (step S900).

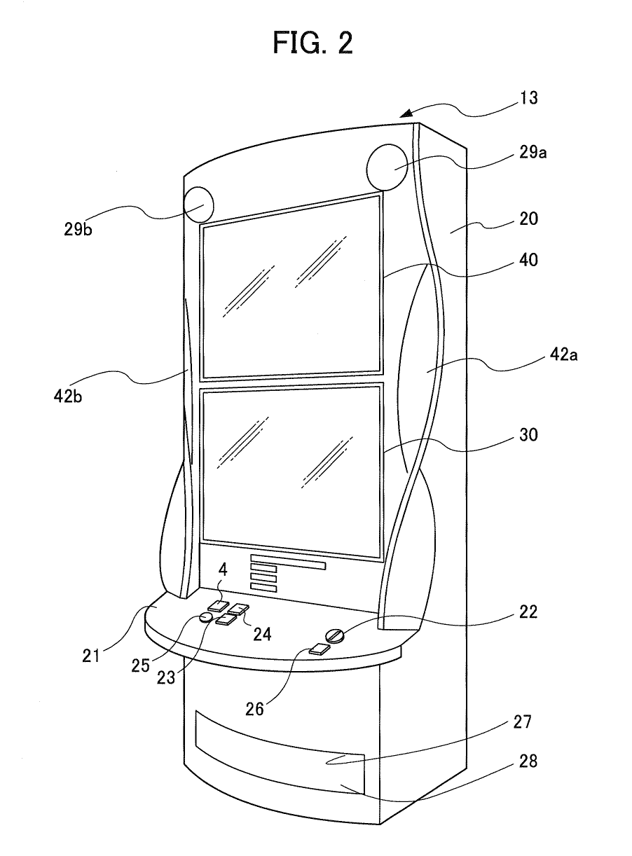

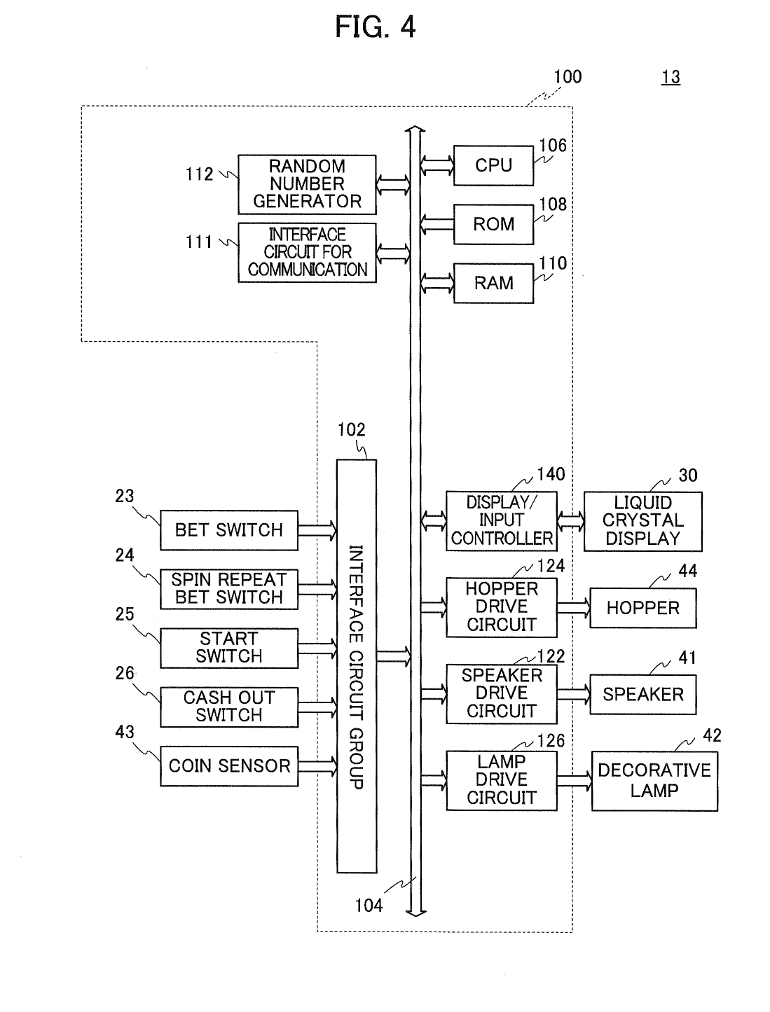

FIG. 2 is a perspective view showing the gaming machine 13 according to an embodiment of the present invention. The gaming machine 13 includes a cabinet 20. The cabinet 20 has a surface opening toward a player. The cabinet 20 contains various components including a game controller 100 (refer to FIG. 4) for electrically controlling the gaming machine 13, and a hopper 44 (refer to FIG. 4) for controlling the insertion, storage, and payout of coins (being one of game media), and the like. The game medium is not limited to coins, and it may be, for example, medals, tokens, electronic money, or electronic valuable information (credits) equivalent to these.

A liquid crystal display 30 is disposed at substantially the center of the front face of the cabinet 20, and a liquid crystal display 40 is disposed above the display 30.

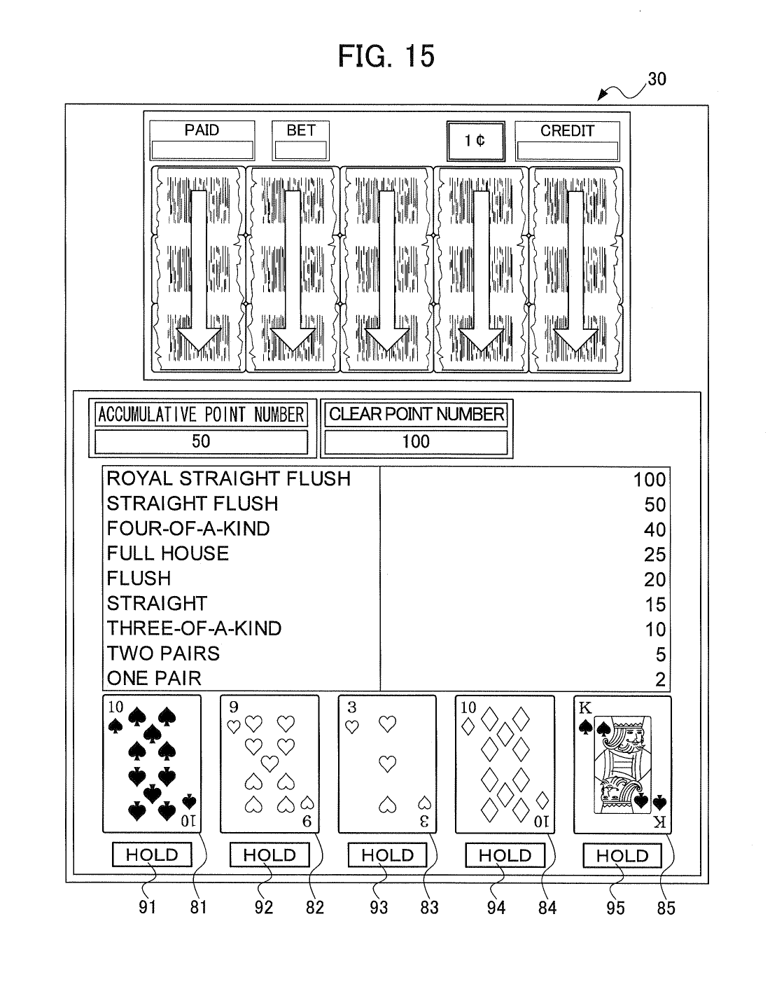

The liquid crystal display 30 realizes a display device for displaying a variety of images related to the game including produced images and the like. The player advances the game while observing the variety of images displayed on the liquid crystal display 30. In such a game, the liquid crystal display 30 displays a slot game and the mini game as shown in FIGS. 15 to 17.

The gaming machine 13 is made up of image reels, and five virtual reels can be displayed on the liquid crystal display 30. The term “image reels” means ones where image reels in place of mechanical reels are displayed on the liquid crystal display 30. As a plurality of types of necessary symbols for the game, the following symbols of “BONUS”, “WILD”, “TREASURE BOX”, “GOLDEN MASK”, “HOLY CUP”, “COMPASS&MAP”, “SNAKE”, “A”, “K”, “Q”, “J”, and “10” are displayed together with images which appear spinning.

The other liquid crystal display 40 above the liquid crystal display 30 is a display functioning as a sub display for displaying the rules of the game, demonstration screens, and the like.

Sound permeable openings 29a and 29b, through which sound effects emitted from a speaker 41 (refer to FIG. 4) contained inside the cabinet 20 are propagated outside the cabinet 20, are disposed on the upper right and left sides of the liquid crystal display 40, respectively. The sound effects in accordance with the progress of the game or the like can be emitted through the sound permeable openings 29a and 29b. Decorative lamps 42a and 42b are disposed on the right and left sides in the middle of the gaming machine 13, respectively. The decorative lamps 42a and 42b emit light in accordance with the progress of the game.

A substantially horizontal operating part 21 is disposed below the liquid crystal display 30. Disposed on the right side of the operating part 21 is a coin slot 22 through which a number of coins are inserted into the gaming machine 13. On the other hand, disposed on the left side of the operating part 21 are a bet switch 23 and a spin repeat bet switch 24. The bet switch 23 is used to choose the number of coins as a game medium to be bet on lines L1, L2, L3, L4, L5, L6, L7, L8, and L9 for awarding nine winnings to be described later (hereinafter abbreviated to “winning lines”), any one of which can be decided so as to activate, and the activated winning is awarded. The spin repeat bet switch 24 is used to repeat the game without changing the number of coins bet on any one of the winning lines in the previous game. The number of coins to be bet on the winning lines can be decided by pressing the bet switch 23 or the spin repeat bet switch 24.

In the operating part 21, a start switch 25 for accepting per game the player's operation of starting a game is disposed on the left side of the bet switch 23. Pressing either the start switch 25 or the spin repeat bet switch 24 triggers the start of the game and then displays an image where the aforesaid five image reels 3A to 3E commence spinning.

Also in the operating part 21, a cash out switch 26 is disposed in the vicinity of the coin slot 22. When the player presses the cash out switch 26, the inserted coins can be discharged from a coin discharge slot 27 opening into a lower part of the front face of the cabinet 20. The discharged coins can be gathered on a coin tray 28.

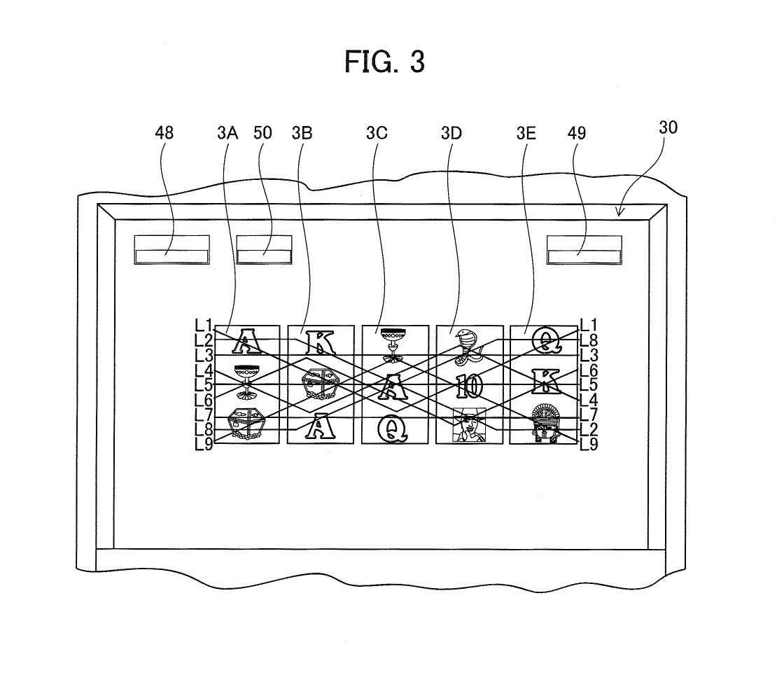

FIG. 3 shows an enlargement of a display area of the gaming machine 13. As shown in FIG. 3, the gaming machine 13 has the lines L1 to L9 for awarding the nine winnings. The lines L1 to L9 extend so as to pass through a symbol on each of the image reels 3A to 3E when the image where all of the spinning five image reels 3A to 3E come to a stop.

Pressing the bet switch 23 once will activate, for example, the line L3 for awarding a third winning, the line L5 for awarding a fifth winning, and the line L7 for awarding a seventh winning, and also take up a coin as a credit medal.

Pressing the bet switch 23 two times will activate, for example, the line L1 for awarding a first winning, the line L4 for awarding a fourth winning, and the line L8 for awarding an eighth winning, in addition to the above-mentioned three lines, and also take up two coins as credit medals.

Pressing the bet switch 23 three times will activate, for example, the line L2 for awarding a second winning, the line L6 for awarding a sixth winning, and the line L9 for awarding a ninth winning, in addition to the above-mentioned six lines, and also take up three coins as credit medals.

An executable game in the present embodiment is a game designed to line up symbols along the winning lines.

It is arranged so that a payout number display part 48, a bet number display part 50, and a credit number display part 49 can be displayed in this order from the left side on the upper part of the liquid crystal display 30. The payout number display part 48 displays the payout number of coins when a combination for awarding a winning is achieved along the winning lines. The credit number display part 49 displays the credit number of coins stored in the gaming machine 13. The bet number display part 50 displays the bet number that is the number of coins bet on the winning lines.

FIG. 4 is a block diagram showing the electrical configuration of the game controller 100 of the gaming machine 13. Referring to FIG. 4, the game controller 100 of the gaming machine 13 is a microcomputer and provided with an interface circuit group 102, an input-output bus 104, a CPU 106, a ROM 108, a RAM 110, an interface circuit 111 for communication, a random number generator 112, a speaker drive circuit 122, a hopper drive circuit 124, a lamp drive circuit 126, and a display/input controller 140.

The interface circuit group 102 is connected to the input-output bus 104 performing input and output of data signals or address signals with respect to the CPU 106.

The start switch 25 is connected to the interface circuit group 102. A start signal outputted from the start switch 25 is converted to a predetermined signal by the interface circuit group 102 and then supplied to the input-output bus 104.

The bet switch 23, the spin repeat bet switch 24, and the cash out switch 26 are also connected to the interface circuit group 102. Switching signals outputted from the switches 23, 24, and 26, respectively, are also supplied to the interface circuit group 102 and converted to predetermined signals and then supplied to the input-output bus 104 by the interface circuit group 102, respectively.

A coin sensor 43 is also connected to the interface circuit group 102. The coin sensor 43 is a sensor for detecting coins inserted into the coin slot 22, and disposed in relation to the coin slot 22. A sensing signal outputted from the coin sensor 43 is also supplied to the interface circuit group 102 and converted to a predetermined signal and then supplied to the input-output bus 104 by the interface circuit group 102.

The ROM 108 and the RAM 110 are connected to the input-output bus 104.

Upon acceptance of the start operation of a game through the start switch 25, the CPU 106 reads a game program to execute the game. The game program is programmed as follows. That is, a display for starting the scroll of the symbols on the five image reels is made on the liquid crystal display 30 via the display/input controller 140. Thereafter, a display for stopping the five image reels is made to rearrange the five image reels. If a combination of stopped symbols at this time is displayed on the winning lines, and the combination corresponds to a specific combination for which a predetermined winning is awarded, a number of coins associated with the specific combination are paid out.

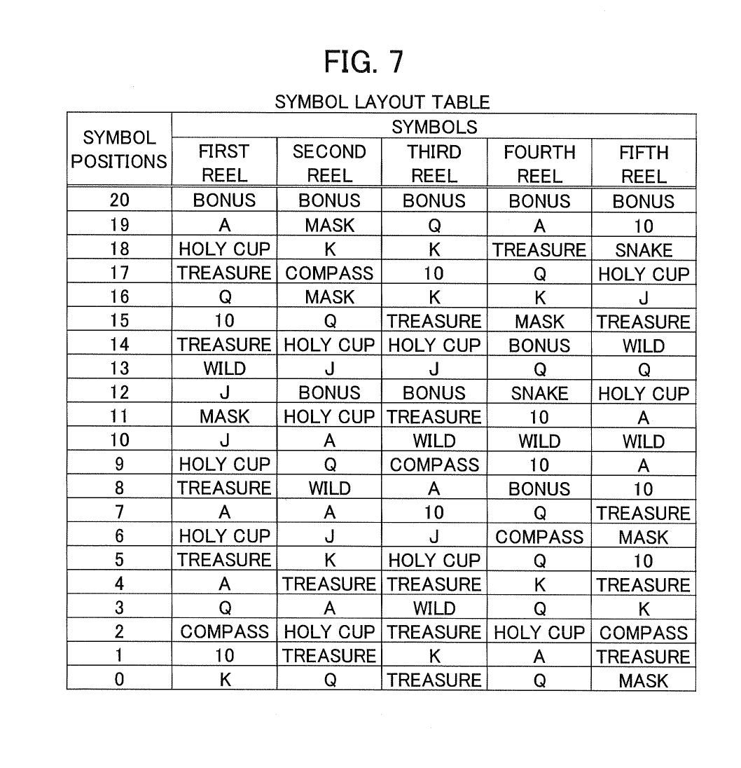

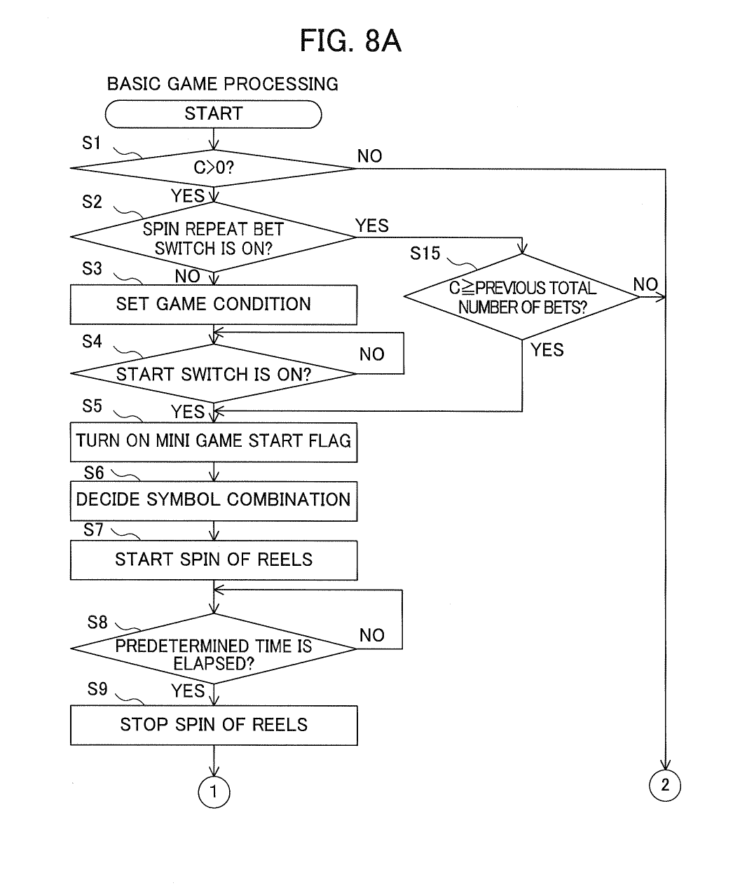

The ROM 108 stores a control program for governing and controlling the gaming machine 13, a program for executing routines as shown in FIGS. 8A to 10 (hereinafter referred to as a “routine execution program”), and initial data for executing the control program, and various data tables used in decision processes. The routine execution program includes the above-mentioned basic game program. As an example of the data tables, there are tables as shown in FIG. 7 and FIGS. 11 to 15. The RAM 110 temporarily stores the values of flags and variables, and the like used in the control program.

The interface circuit 111 for communication is also connected to the input-output bus 104. The interface circuit 111 for communication is a circuit for communication with a center controller 11 and the like over a network 12 including a variety of Local Area Networks (LAN).

The random number generator 112 for generating random numbers is also connected to the input-output bus 104. The random number generator 112 generates random numbers included in a certain range of numerical values, for example, “0” to “65535 (2¹⁶-1).” Alternatively, the random numbers may be generated by the arithmetic processing of the CPU 106.

The speaker drive circuit 122 for driving the speaker 41 is also connected to the input-output bus 104. The CPU 106 reads sound data stored in the ROM 108, and sends the read sound data to the speaker drive circuit 122 via the input-output bus 104. This enables the speaker 41 to emit predetermined sound effects.

The hopper drive circuit 124 for driving the hopper 44 is also connected to the input-output bus 104. If a cash out signal from the cash out switch 26 is inputted, the CPU 106 outputs a drive signal to the hopper drive circuit 124 via the input-output bus 104. This enables the hopper 44 to pay out a number of coins corresponding to the remainder of credits at that point, which is stored in a predetermined memory area of the RAM 110.

Alternatively, the payout of the coins may be performed in a mode of storing credit data in a data card or the like, instead of using physical coins. That is, the player may carry a card functioning as a recording medium, and store the data related to the credit by inserting the card into the gaming machine 13.

The lamp driving circuit 126 for driving the decorative lamps 42a and 42b is also connected to the input-output bus 104. The CPU 106 sends signals for driving the lamps under a predetermined condition based on the program stored in the ROM 108, to the lamp driving circuit 126. This flickers the decorative lamps 42a and 42b.

The display/input controller 140 is also connected to the input-output bus 104. The CPU 106 generates an image display instruction according to the state of the game and the outcome of the game, and outputs the generated image display instruction to the display/input controller 140 via the input-output bus 104. If the image display instruction from the CPU 106 is inputted, the display/input controller 140 generates a drive signal for driving the liquid crystal display 30 based on the inputted image display instruction, and outputs the generated drive signal to the liquid crystal display 30. This enables a predetermined image to be displayed on the liquid crystal display 30. The display/input controller 140 also sends, as an input signal, the signal accepted by a touch panel 32 on the liquid crystal display 30, via the input-output bus 104 to the CPU 106. The image display instruction also contains the instructions in accordance with the payout number display part 48, the credit number display part 49, and the bet number display part 50.

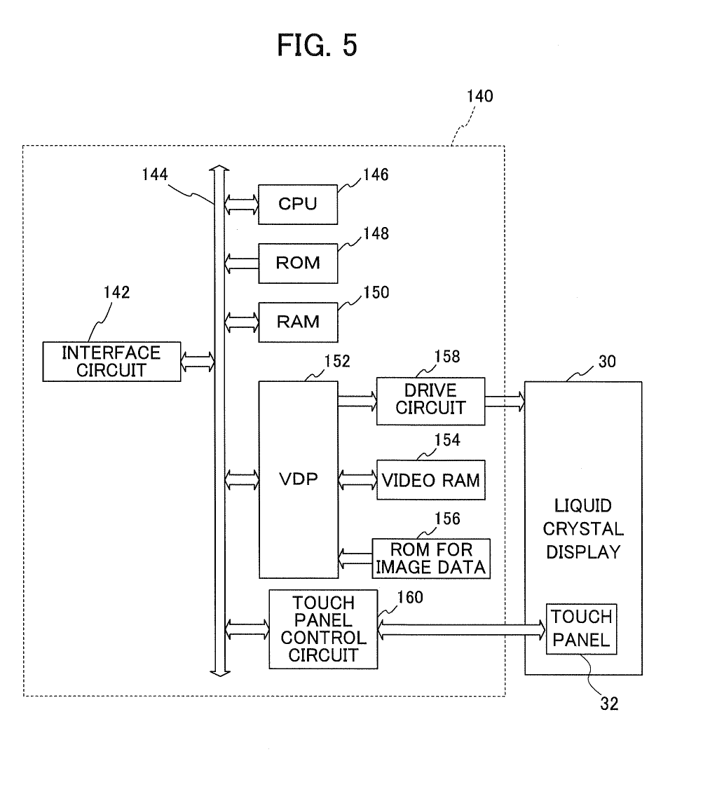

FIG. 5 is a block diagram showing the electrical configuration of the display/input controller 140 of the gaming machine 13. The display/input controller 140 is a sub-micro computer which performs image display processing and the control of input from the touch panel 32, and which has an interface circuit 142, an input-output bus 144, a CPU 146, a ROM 148, a RAM 150, a VDP 152, a video RAM 154, a ROM 156 for image data, a drive circuit 158, and a touch panel control circuit 160.

The interface circuit 142 is connected to the input-output bus 144. An image display instruction outputted from the CPU 106 on the above-mentioned game controller 100 is supplied to the input-output bus 144 via the interface circuit 142. The input-output bus 144 performs input and output of data signals or address signals with respect to the CPU 146.

The ROM 148 and the RAM 150 are connected to the input-output bus 144. The ROM 148 stores a display control program under which a drive signal to be supplied to the liquid crystal display 30 is generated based on the image display instruction from the CPU 106 on the game controller 100. On the other hand, the RAM 150 stores the values of flags and variables used in the aforesaid control program.

The VDP 152 is also connected to the input-output bus 144. The VDP 152 is a processing unit including a so-called sprite circuit, a screen circuit, and a palette circuit, thus enabling to perform different processes for displaying images on the liquid crystal display 30. The video RAM 154 and the ROM 156 are connected to the VDP 152. The video RAM 154 stores image data based on the image display instructions from the CPU 106 on the game controller 100. The ROM 156 for image data stores various kinds of image data containing the above-mentioned produced image data. Further connected to the VDP 152 is the drive circuit 158 which outputs a drive signal for driving the liquid crystal display 30.

By reading and executing the display control program stored in the ROM 148, the CPU 146 instructs the video RAM 154 to store image data to be displayed on the liquid crystal display 30 in response to the image display instruction from the CPU 106 on the game controller 100. The image display instruction contains various types of image display instructions such as the display instruction of the above-mentioned produced image.

The ROM 156 for image data stores various kinds of image data such as the produced image data.

The touch panel control circuit 160 sends, as an input signal, the signal inputted through the touch panel 32 on the liquid crystal display 30, via the input-output bus 144 to the CPU 106.

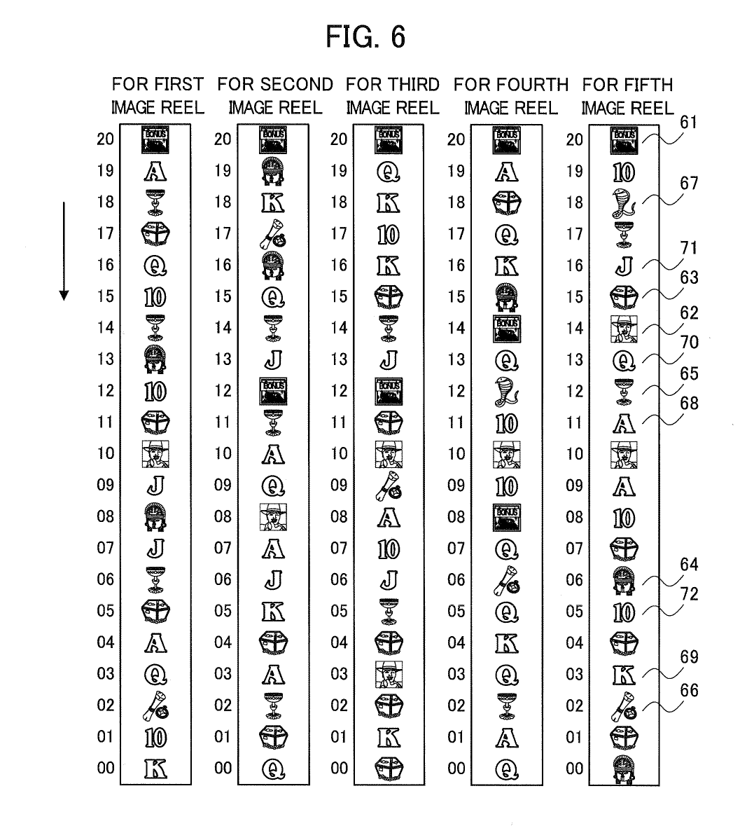

FIG. 6 shows columns of symbols where 21 symbols are represented and arranged on image reels 3A to 3E, respectively. The columns of symbols for a first image reel corresponds to an image reel 3A, the column of symbols for a second image reel corresponds to an image reel 3B, the column of symbols for a third image reel corresponds to an image reel 3C, the column of symbols for a fourth image reel corresponds to an image reel 3D, and the column of symbols for a fifth image reel corresponds to an image reel 3E.

Referring to FIG. 6, code numbers of “00” to “20” are allocated to the symbols of the image reels 3A to 3E, respectively, and these code numbers are tabled and stored in the aforesaid ROM 108 (FIG. 4) as a data table.

The column of symbols is represented on the image reels 3A to 3E, respectively. Specifically, the column of symbols is made up of “BONUS” symbol (symbol 61) (hereinafter abbreviated to “BONUS”), “WILD” symbol (symbol 62) (hereinafter abbreviated to “WILD”), “TREASURE BOX” symbol (symbol 63) (hereinafter abbreviated to “TREASURE BOX”), “GOLDEN MASK” symbol (symbol 64) (hereinafter abbreviated to “GOLDEN MASK”), “HOLY CUP” symbol (symbol 65) (hereinafter abbreviated to “HOLY CUP”), “COMPASS&MAP” symbol (symbol 66) (hereinafter abbreviated to “COMPASS&MAP”), “SNAKE” symbol (symbol 67) (hereinafter abbreviated to “SNAKE”), “A” symbol (symbol 68) (hereinafter abbreviated to “A”), “K” symbol (symbol 69) (hereinafter abbreviated to “K”), “Q” symbol (symbol 70) (hereinafter abbreviated to “Q”), “J” symbol (symbol 71) (hereinafter abbreviated to “J”), and “10” symbol (symbol 72) (hereinafter abbreviated to “10”). The columns of symbols on the image reels 3A to 3E can be moved by the display of an image where the reels 3A to 3E are spinning in a forward direction.

In the present embodiment, “BONUS”, “WILD”, “SNAKE”, “TREASURE BOX”, “GOLDEN MASK”, “HOLY CUP”, “COMPASS&MAP”, “A”, “K”, “Q”, “J”, and “10” are provided as the role in awarding a predetermined winning. The roles (role data) are basically control information which are the associations between advantages given to a player (the numbers of payout coins) and winning symbol combinations, respectively, and which are used to control the stop of the image reels 3A to 3E, the switching (conversion) of the state of the game, and the supply of coins.

FIG. 7 shows a symbol layout table. In the symbol layout table, the individual symbols on the image reels 3A to 3E are entered in association with the code numbers designating the positions of the symbols in the aforesaid columns of symbols, respectively. The first to fifth image reels correspond to the image reels 3A to 3E, respectively. In other words, the symbol layout table contains the information of the symbols corresponding to the symbol positions (the code numbers) of the image reels 3A to 3E, respectively.

In FIG. 7, “TREASURE,” “MASK,” and “COMPASS” are abbreviations for the above-mentioned “TREASURE BOX,” “GOLDEN MASK,” and “COMPASS&MAP,” respectively.

FIGS. 8A and 8B show the flow chart showing the flow of processing in the basic game of the gaming machine 13 to be executed by the game controller 100 of the gaming machine 13. A routine in FIGS. 8A and 8B is a unit game.

Supposing that the gaming machine 13 is activated in advance and the variables used in the CPU 106 on the game controller 100 are initialized to predetermined values, respectively, thereby providing a stationary action of the gaming machine 13.

Firstly, the CPU 106 on the game controller 100 decides whether there remains a certain credit being the number of remaining coins inserted by the player (step S1). Specifically, the CPU 106 reads a credit number C stored in the RAM 110, and performs processing based on the read credit number C. When the credit number C is “0” (when the result is NO in step S1), the CPU 106 cannot start any game and hence terminates the present routine without performing any processing. On the other hand, when the credit number C is “1” or more (when the result is YES in step S1), the CPU 106 decides that the credit remains, and moves on to step S2.

In step S2, the CPU 106 decides whether the spin repeat bet switch 24 has been pressed. When the spin repeat bet switch 24 is already pressed and an operation signal from the switch 24 is then inputted (when the result is YES in step S2), the CPU 106 moves on to step S15. On the other hand, when no operation signal from the switch 24 is inputted in a predetermined period of time (when the result is NO in step S2), the CPU 106 decides that the spin repeat bet switch 24 is not pressed, and moves on to step S3.

In step S3, a game condition is set. Specifically, the CPU 106 decides the number of coins to be bet on the winning lines in the present game, depending on the operation of the bet switch 23. At this time, the CPU 106 receives operation signals sent in accordance with the operation of the bet switch 23 and, based on the number of the received operation signals, causes the number of bets on the winning lines to be stored in a predetermined memory area of the RAM 110. The CPU 106 reads the credit number C written in the predetermined memory area of the RAM 110, and subtracts the total number of bets including the aforesaid number of bets from the read credit number C. Then, the CPU 106 causes the resulting value to be stored in a predetermined memory area of the RAM 110. The CPU 106 then moves on to step S4.

In step S4, the CPU 106 waits for the operation of the start switch 25 by deciding whether the start switch 25 is ON. When the start switch 25 is operated and an operation signal from the start switch 25 is then inputted (when the result is YES in step S4), the CPU 106 decides that the start switch 25 has been operated, and then moves on to step S5.

On the other hand, in step S15, the CPU 106 decides whether the value of the credit number C is not less than the value of the total number of bets in the previous game. In other words, the CPU 106 decides whether the game can be started by the operation of pressing the spin repeat bet switch 24. Specifically, when the spin repeat bet switch 24 is pressed and an operation signal is then inputted from the switch 24, the CPU 106 reads the credit number C written in a predetermined memory area of the RAM 110 and the number of bets related to the winning lines L1 to L9 in the previous game, and then performs processing based on the relationship between the read credit number C and the read number of bets, namely whether the value of the credit number C is not less than the value of the total number of bets in the previous game. When the CPU 106 decides that the former value is less than the latter value (when the result is NO in step S15), the CPU 106 cannot start any game and hence terminates the present routine without performing any processing. On the other hand, when the former value is not less than the latter value (when the result is YES in step S15), the CPU 106 subtracts the value of the total number of bets in the previous game from the value of the credit number C, and causes the resulting value to be stored in a predetermined memory area of the RAM 110. The CPU 106 then moves on to step S5.

In step S5, the CPU 106 performs processing to turn on a mini game start flag. Specifically, the CPU 106 writes data indicating that the mini game start flag is ON, in the storage area of the mini game start flag in the RAM 110. The CPU 106 then moves on to step S6.

In step S6, the CPU 106 performs a combination decision processing. The specific contents of the combination decision processing are as follows.

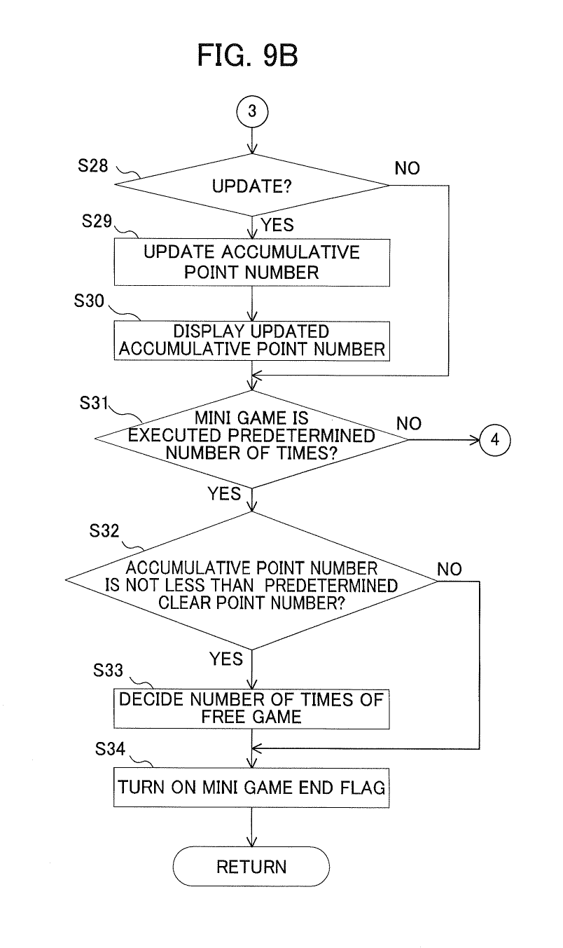

In the combination decision processing, firstly, the CPU 106 decides a combination of stopped symbols along the winning lines. Specifically, the CPU 106 issues an order of generating a random number to a random number generator 112, and extracts a random number in a predetermined range (“0” to “65535” in the present embodiment) generated by the random number generator 112. The CPU 106 causes the extracted random number to be stored in a predetermined memory area of the RAM 110. In the present embodiment, random numbers can be generated in the random number generator 112 disposed outside the CPU 106. Alternatively, random numbers may be generated by the arithmetic operation of the CPU 106, without disposing the random number generator 112. The CPU 106 reads a random number table and a specific combination table (a random number table for the basic game (refer to FIG. 11)) used in awarding a predetermined winning, both of which are stored in the ROM 108, and stores the read random number table and the read specific combination table in a predetermined memory area of the RAM 110. At this time, the CPU 106 controls to stop and display for each reel, based on the random number table. The CPU 106 decides a combination of stopped symbols relating to the winning lines by reading the random number table and the specific combination table each being stored in the predetermined memory area of the RAM 110, and referring to the random number table by using, as a parameter, the random number values written in a predetermined memory area of the RAM 110. Thus, the CPU 106 decides a specific combination for awarding a predetermined winning, and then causes the data of this specific combination to be stored in a predetermined memory area of the RAM 110. The CPU 106 reads the random number value and the combination data each being written in the predetermined memory area of the RAM 110 and, based on these, decides a combination of stopped symbols to be stopped and displayed. At this time, the symbol layout table stored in the ROM 108 is read and stored in a predetermined memory area of the RAM 110, and also referred to by the CPU 106. The CPU 106 causes the decided combination of stopped symbols to be stored in a predetermined memory area of the RAM 110. Alternatively, the aforesaid random number table may be used to decide a stopped symbol for each reel.

After deciding the combination of stopped symbols relating to the winning lines, the CPU 106 decides if the decided combination corresponds to a specific combination for awarding a predetermined winning. If so, in order to generate, on the winning lines, a winning corresponding to the combination of symbols as a specific combination for providing the decided winning, the CPU 106 activates a flag indicating the provision of the winning designated by the type of the specific combination. The flag indicating the provision of the activated winning is then stored in a predetermined memory area of the RAM 110 by the CPU 106. On the other hand, when the combination of stopped symbols relating to the winning lines is a different combination, namely a non-winning combination, the CPU 106 does not activate the flag indicating the provision of the aforesaid winning. The CPU 106 then moves on to step S7.

In step S7, the CPU 106 executes the display of an image where the image reels 3A to 3E have commenced spinning. Specifically, the CPU 106 executes the display of an image where the image reels 3A to 3E spin in sequence or at the same time.

The CPU 106 waits until a predetermined period of time is elapsed after displaying an image where the image reels 3A to 3E have commenced spinning (step S8). At the point where the predetermined period of time is elapsed (at the point that the result is YES in step S8), the CPU 106 automatically stops the spinning of the image reels 3A to 3E (step S9). Specifically, based on the specific combination for providing the winning written in the predetermined memory area of the RAM 110, the CPU 106 performs such a display as to stop the images of the spinning image reels 3A to 3E in sequence or at the same time, so that stopped symbols corresponding to the specific combination for providing the winning decided in step S5 can be displayed in a display area having a visually interactive relationship with the player. The CPU 106 then moves on to step S10.

In step S10, the CPU 106 decides whether a predetermined combination of symbols is achieved by the combination decision processing in step S6. Specifically, the CPU 106 decides based on the state of the flag indicating the provision of a winning relating to the winning lines stored in the predetermined memory area of the RAM 110. When the flag indicating the provision of the winning is not activated, namely when the specific combination for providing the winning is “others” (when the result is NO in step S10), the CPU 106 decides that the specific combination for providing the winning is not achieved, and terminates the present routine. On the other hand, when the aforesaid flag is activated, namely when the aforesaid specific combination is other than the “others” (when the result is YES in step S10), the CPU 106 moves on to step S11.

In step S11, the CPU 106 decides whether the achieved symbol combination is “BONUS” by the combination decision processing in step S6. Specifically, when it is “BONUS” (when the result is YES in step S11), the CPU 106 moves on to step S12. On the other hand, when it is not “BONUS” (when the result is NO in step S11), the CPU 106 moves on to step S14.

In step S12, the CPU 106 decides whether a mini game end flag is ON. Specifically, the CPU 106 decides if data indicating the mini game end flag is ON are written in the area of the mini game end flag in the RAM 110. If so, the CPU 106 moves on to step S13. If not, it moves on to step S12.

In step S13, the CPU 106 performs a free game processing. The CPU 106 then terminates the present routine.

In step S14, the CPU 106 pays out a number of coins corresponding to the above-mentioned specific combination for providing the winning. Specifically, the CPU 106 refers to a payout table and calculates a payout number of coins corresponding to this specific combination. The CPU 106 reads the credit number stored in the predetermined memory area of the RAM 110, and adds the calculated payout number to the read credit number, and then causes the resulting value to be stored in a predetermine memory area of the RAM 110. The CPU 106 also causes the stored value to be displayed on the credit number display part 49. The CPU 106 then terminates the present routine.

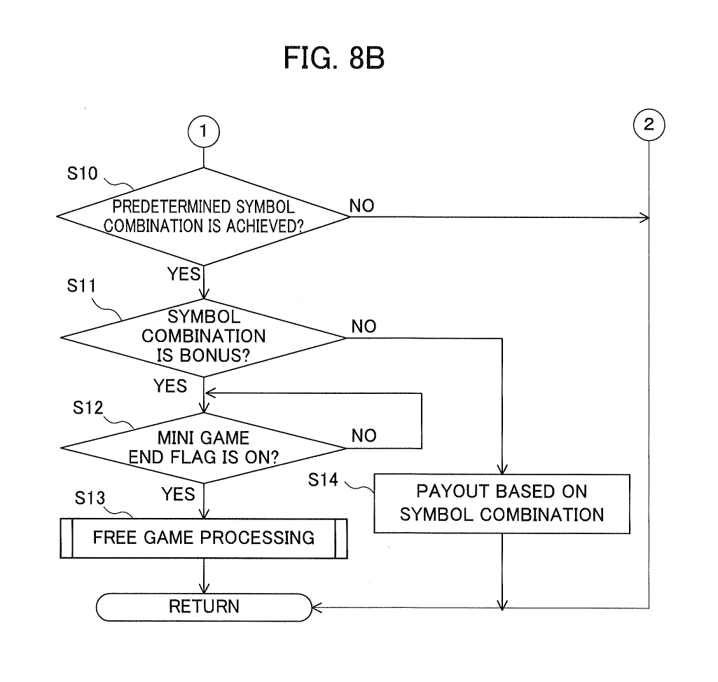

The mini game processing will be described below with reference to FIGS. 9A and 9B.

In step S21, the CPU 106 decides whether a mini game start flag is ON. Specifically, the CPU 106 decides if data indicating the mini game start flag is ON are written in the area of the mini game start flag in the RAM 110. If so, the CPU 106 moves on to step S22. If not, it moves on to step S21.

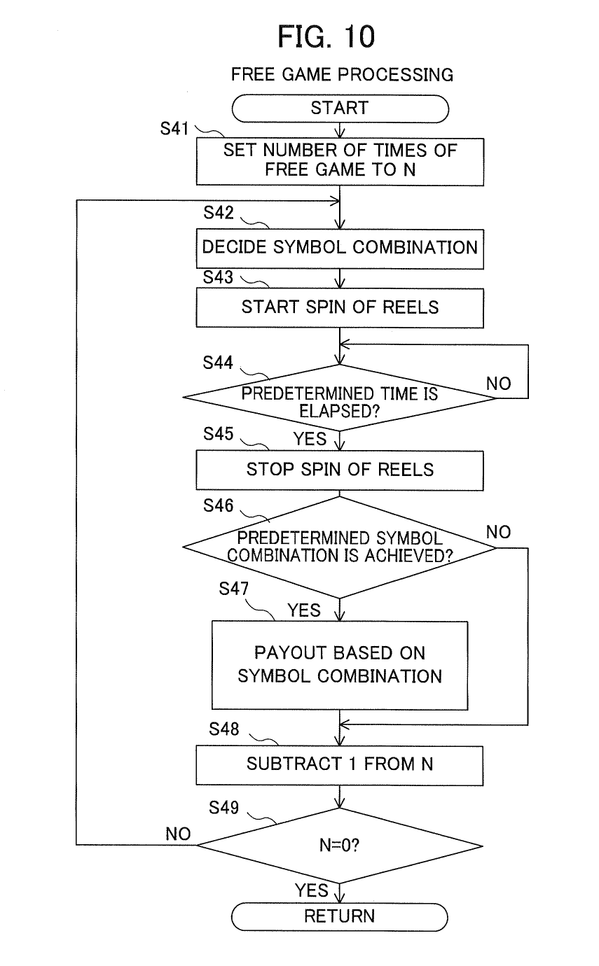

In step S22, the CPU 106 performs processing to display an image of a predetermined number of cards, and moves on to step S23. Specifically, the CPU 106 refers to a random number table for poker role decision to be described later with reference to FIG. 12, and decides the poker role based on a random number value generated by the random number generator 112, and then displays a card image based on the decided poker role on the liquid crystal display 30.

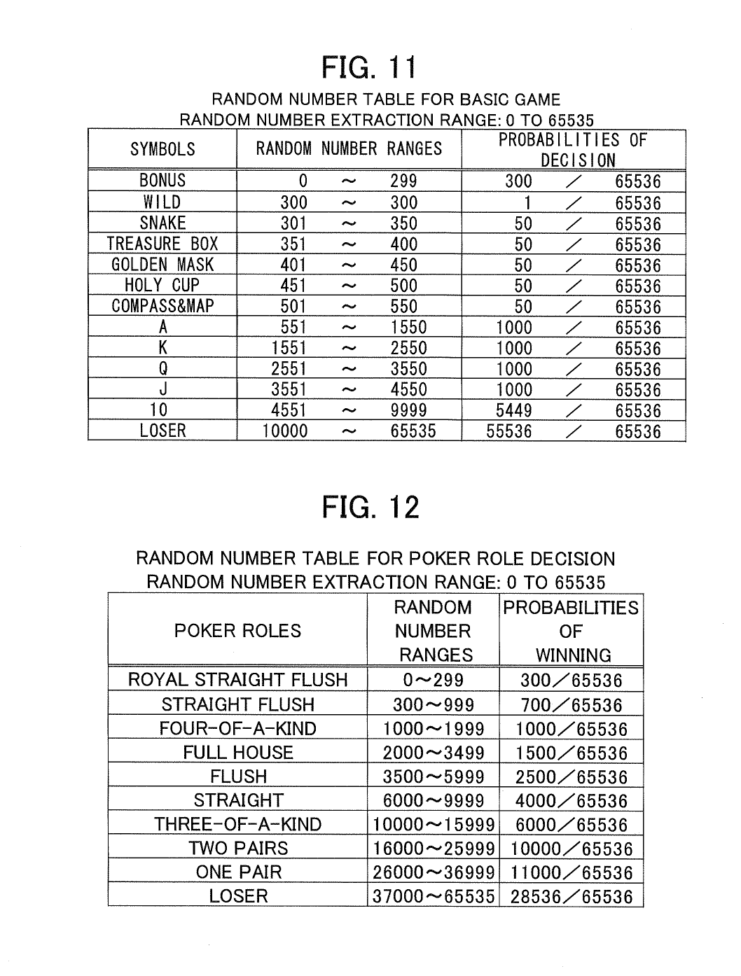

In step S23, the CPU 106 performs processing to display a point number corresponding to a card image combination, and moves on to step S24. Specifically, the CPU 106 refers to a point number table to be described later with reference to FIG. 13, and displays a point number corresponding to each poker role, on the liquid crystal display 30.

In step S24, the CPU 106 performs processing to display a predetermined clear point number, and moves on to step S25. Specifically, the CPU 106 displays, on the liquid crystal display 30, a predetermined clear point number stored in a predetermined storage area of the RAM 110, as the necessary point number for executing the free game more than a normal number of times (for example, 50 times).

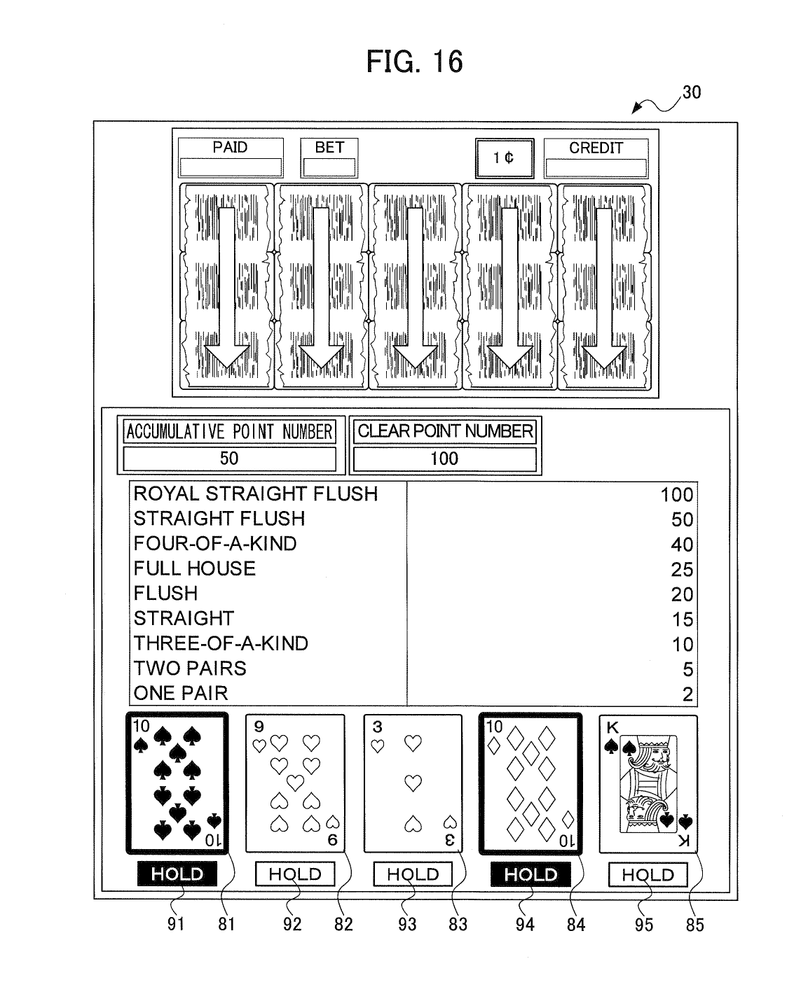

In step S25, the CPU 106 decides if card image identification data are received before an elapse of a predetermined time. If so, the CPU 106 moves on to step S26. If not, it moves on to step S27. Specifically, the CPU 106 decides if card image identification data identifying a card image selected by a player are received before an elapse of a predetermined time from the start of execution of the mini game. Here, the term “card image selected by the player” means a card image the player selected so as to remain from a predetermined number of card images displayed in a card replacement processing in step S26 to be described later. A specific example thereof will be described with reference to FIG. 16.

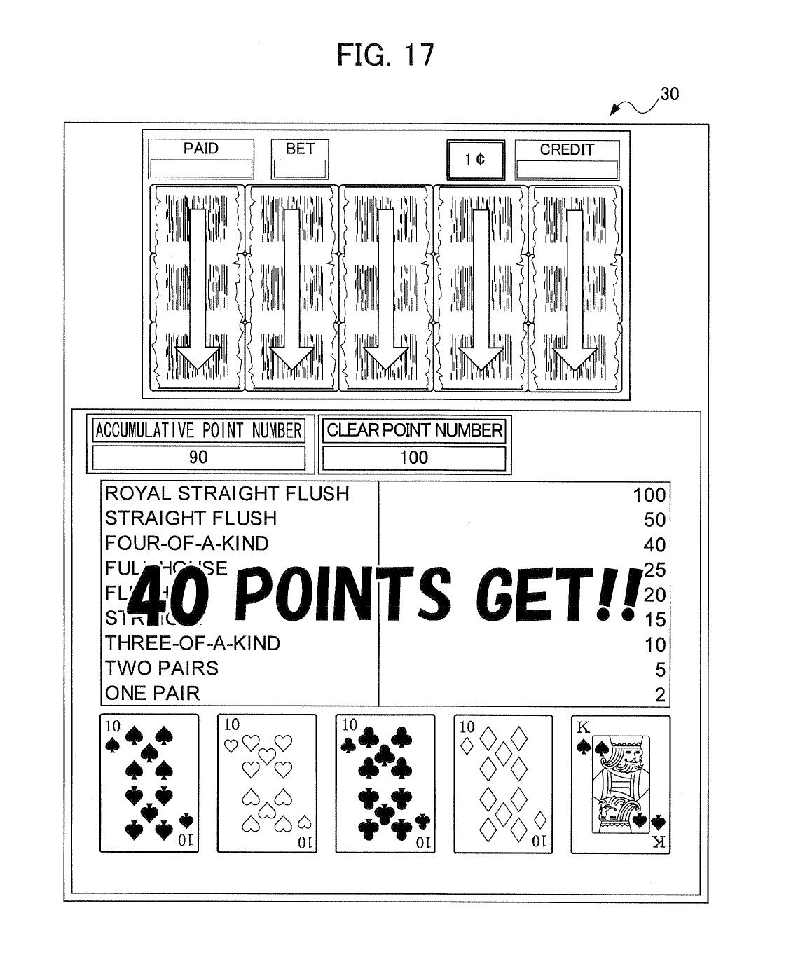

In step S26, the CPU 106 performs processing to display by replacing a predetermined number of card images, and then moves on to step S27. Specifically, the CPU 106 displays intactly a card image corresponding to the card image identification data received in step S25, in the predetermined number of card images displayed in step S22, and displays by replacing the rest with another card image. In this case, in order to decide a card image for replacement, the CPU 106 decides a poker role by referring to a random number table for poker role decision to be described with reference to FIG. 12, and then decides and displays a card image corresponding to the decided poker role on the liquid crystal display 30. A specific example thereof will be described with reference to FIG. 17.

In step S27, the CPU 106 decides whether to update the accumulative point number, and moves on to step S28. The term “accumulative point number” means a point number to be updated depending on the outcome of the mini game, which is stored in a predetermined area of the RAM 110. As a specific processing in step S28, the CPU 106 decides to update the accumulative point number when the point number corresponding to the poker role decided in step S22 is greater than zero, and decides not to update the accumulative point number when it is not greater than zero.

In step S28, the CPU 106 decides whether to update the accumulative point number, and moves on to step S29 when a decision is made to update, and moves on to step S31 when a decision is made not to update. As a specific processing in step S28, the CPU 106 decides whether a decision has been made to update the accumulative point number in step S27.

In step S29, the CPU 106 performs processing to update the accumulative point number, and moves on to step S30. Specifically, the CPU 106 updates by adding the point number corresponding to the poker role decided in step S22, to the accumulative point number stored in the predetermined storage area of the RAM 110.

In step S30, the CPU 106 performs processing to display the updated accumulative point number, and moves on to step S31. Specifically, the CPU 106 displays, on the liquid crystal display 30, the accumulative point number stored in the predetermined storage area of the RAM 110.

In step S31, the CPU 106 decides if the mini game has been executed a predetermined number of times. If so, the CPU 106 moves on to step S32. If not, it moves on to step S34. Specifically, the CPU 106 reads the number of time of execution of the mini game stored in a predetermined storage area of the RAM 110, and decides whether the read number of times of the execution is a predetermined number of times.

In step S32, the CPU 106 decides if the accumulative point number is not less than a predetermined clear point number. If so, the CPU 106 moves on to step S33. If not, it moves on to step S34. Specifically, the CPU 106 decides whether the accumulative point number is not less than the predetermined clear point number stored in a predetermined storage area of the RAM 110.

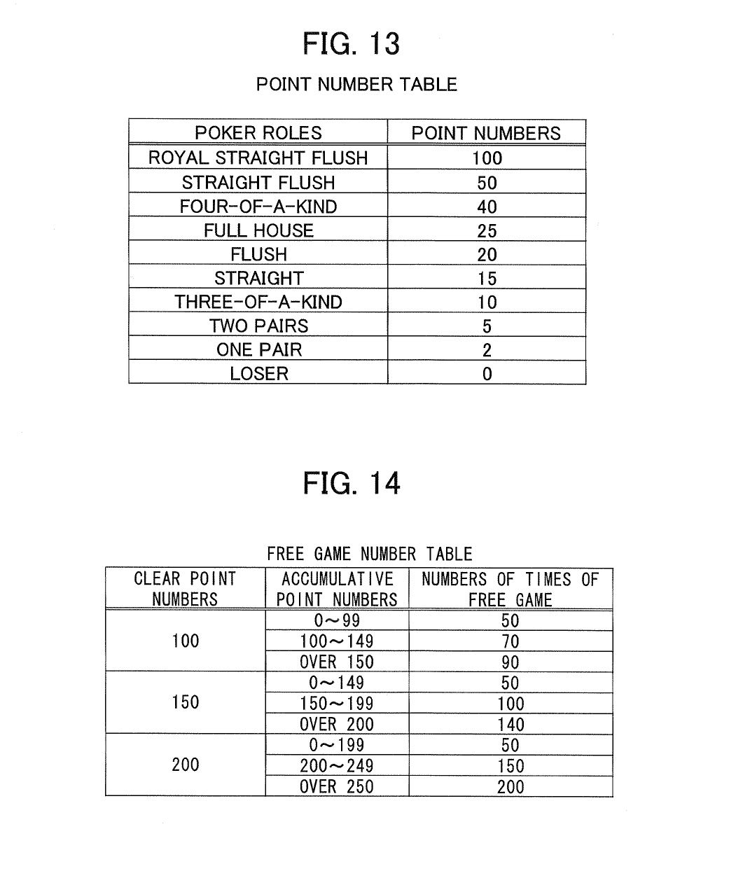

In step S32, the CPU 106 decides the number of times of the free game, and moves on to step S33. Specifically, the CPU 106 refers to a free game number table to be described with reference to FIG. 14, and decides the number of times of the free game, depending on the accumulative point number.

In step S34, the CPU 106 performs processing to turn on a mini game end flag. Specifically, the CPU 106 writes data indicating the mini game end flag is ON, in the storage area of the mini game end flag in the RAM 110. The CPU 106 then terminates the present routine.

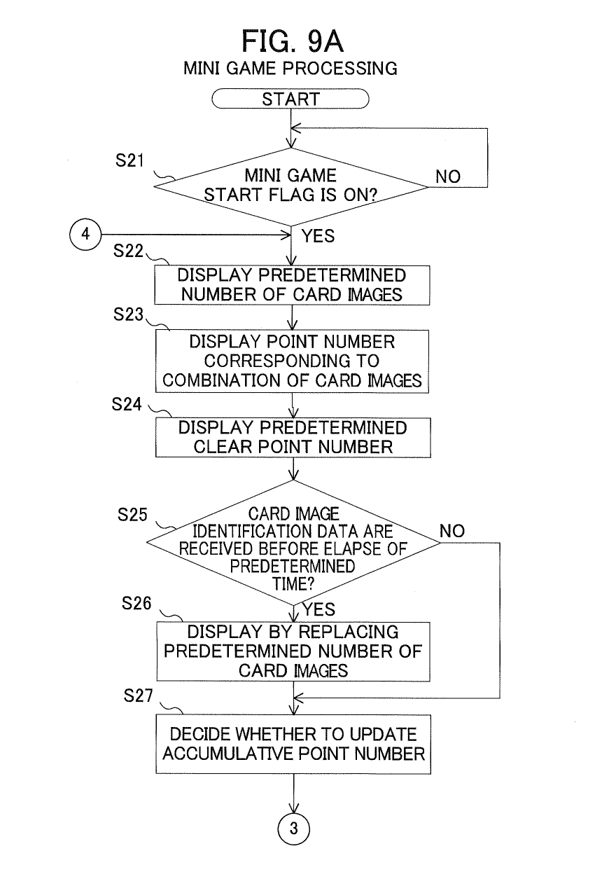

The free game processing will be described below with reference to FIG. 10.

In step S41, the CPU 106 sets a free game number to N, and moves on to step S42. The number of times of the free game is that decided in step S31 as described above with reference to FIG. 9B.

In step S42, the CPU 106 performs a symbol combination decision processing, and moves on to step S43. The specific content of the symbol combination decision processing is substantially identical to that in step S6 as described above with reference to FIG. 8A. The different point is that the CPU 106 refers to a random number table for the free game (not shown).

Returning to FIG. 10, in step S43, the CPU 106 performs a display of an image where the image reels 3A to 3E have commenced spinning, and moves on to step S44. The specific processing content is identical with that in step S7 as described above with reference to FIG. 8A.

Returning to FIG. 10, in step S44, the CPU 106 decides if a predetermined period of time is elapsed. If so, the CPU 106 moves on to step S45. If not, it moves on to step S44. The specific processing content is identical to that in step S8 as described above with reference to FIG. 8A.

Returning to FIG. 10, in step S45, the CPU 106 performs a display of an image where the spinning image reels 3A to 3E come to a stop, and moves on to step S46. The specific processing content is identical with that in step S9 as described above with reference to FIG. 8A.

Returning to FIG. 10, in step S46, the CPU 106 decides if a predetermined symbol combination is achieved. If so, the CPU 106 moves on to step S47. If not, it moves on to step S48. The specific processing content is identical to that in step S10 as described above with reference to FIG. 8B.

Returning to FIG. 10, in step S47, the CPU 106 performs a payout based on the symbol combination, and moves on to step S48. Specifically, the CPU 106 refers to a payout table for the free game (not shown), and calculates a payout number of coins corresponding to the symbol combination for which a predetermined winning is provided. The CPU 106 reads the credit number stored in the predetermined memory area of the RAM 110, and adds the calculated value to the read credit number, and then causes the resulting value to be stored in a predetermine memory area of the RAM 110. The CPU 106 also causes the stored value to be displayed on the credit number display part 49.

In step S48, the CPU 106 performs processing to subtract one from N, and moves on to step S49.

In step S49, the CPU 106 decides if N is zero. If not, the CPU 106 moves on to step S42. If so, it terminates the present routine.

FIG. 11 shows a random number table for the basic game to be referred to in the slot game as described above with reference to FIGS. 8A and 8B. In this table, a random number range and a winning probability are entered in association with each specific combination for providing a predetermined winning. Therefore, when in the combination decision processing (step S6 in FIG. 8A), a random number is extracted, for example, in the range of “0” to “299” in the random numbers of “0” to “65535,” it can be decided in the gaming machine 13 to generate, as a final game outcome, a specific combination for providing the winning of “BONUS.” In other words, the probability that a combination of stopped symbols will be decided as the specific combination for providing the winning of “BONUS” is “300/65536.”

The random number table for poker role decision will be described below with reference to FIG. 12. The random number table for poker role decision is the table to which the CPU 106 refers in the processing for displaying a predetermined number of card images (step S22 in FIG. 9A). In the processing for displaying a predetermined number of card images, for example, when the random number generated by the random number generator 112 is “7000,” this is within the random number range of “6000 to 9999” and therefore the poker role is decided to be “straight.”

The term “poker role” will be described below. The poker role in the present embodiment is the mode where a part or all of five cards displayed on the liquid crystal display 30 match according to a certain rule. Specifically, there are, for example, “one pair,” “two pairs,” “three-of-a-kind,” “straight,” “flush,” “full house,” “four-of-a-kind,” “straight flush,” and “royal straight flush.”

The “one pair” is the event that there are two cards of the same figure. The “two pairs” is the event that there are two sets of two cards of the same figure. The “three-of-a-kind” is the event that there are three cards of the same figure. The “straight” is the event that five cards whose figures are in series irrespective of the type of the suit. The “flush” is the event that there are five cards of the same type irrespective of the figure. The “full house” is the event that there are a set of three cards of the same figure and a set of two cards of the same figure. The “four-of-a-kind” is the event that there are four cards of the same figure. The “straight flush” is the event that there are five cards of the same suit in series. The “royal straight flush” is the event that there are five cards of the same suit and of a series of 10, J, Q, K, and A.

The point number table will be described with reference to FIG. 13. The point number table is the table to which the CPU 106 refers when deciding the point number of the poker role decided in step S22 in FIG. 9A. For example, when the poker role is “straight,” the point number is decided to be “15.” The CPU 106 also refers to this table in the processing for displaying the point number corresponding to a card image combination (step S23 in FIG. 9A).

The free game number table will be described with reference to FIG. 14. The free game number table is the table to which the CPU 106 refers when deciding the number of times of the free game, depending on the accumulative point number. In the processing of deciding the number of times of the free game (step S31 in FIG. 9B), when the clear point number is “100,” the number of times of the free game is decided to be “70” where the accumulative point number is “120.” If the accumulative point number is “80” when the clear point number is “100,” it does not exceed the clear point number and hence the number of times of the free game is decided to be a normal number of times (for example, 50 times).

Similarly, in the processing of deciding the number of times of the free game (step S31 in FIG. 9B), when the clear point number is “150,” the number of times of the free game is decided to be “100” where the accumulative point number is “180.” If the accumulative point number is “120” when the clear point number is “150,” it does not exceed the clear point number and hence the number of times of the free game is decided to be a normal number of times (for example, 50 times).

For example, when the accumulative point number is “150,” the number of times of the free game decided is “90” where the clear point number is “100,” and the number of times of the free game decided is “100” where the clear point number is “150.” Thus, if the accumulative point number reaches the clear point number, a higher clear point increases the number of times of the free game.

In the present embodiment, as the accumulative point number is increased by the repetitive execution of the mini game, the number of times of the free game is increased. Hence, the player will be interested in the mini game during the free game. Further, a higher clear point number increases the number of times of the free game to be decided when the accumulative point number reaches the clear point number. Consequently, the player will be interested in the mini game in order to get a higher number of times of the free games. This further enhances the entertainment properties.

Additionally, in cases where the free game is terminated once and the next transition to the free game occurs soon, checking the accumulative point number enables the player to judge whether he/she can get a higher number of times of the free game than the normal number of times, or he/she will get the normal number of times of the free game. Hence, the player can decide whether to continue playing without changing the current gaming machine.

FIGS. 15 to 19 are diagrams showing produced images in the mini game. In FIGS. 15 to 19, the images of the basic game are displayed on the upper display area in the display area of the liquid crystal display 30, and the images of the mini game are displayed on the lower display area.

The image of the mini game in FIG. 15 will be described here. FIG. 15 shows the situation where five cards (a card 81, a card 82, a card 83, a card 84, and a card 85) are displayed in sequence from the left with their respective surface sides facing up. This situation further includes that hold buttons 91, 92, 93, 94, and 95 correspond to the cards 81, 82, 83, 84, and 85, respectively; that there is a table where poker roles are associated with point numbers, respectively; and that the accumulative point number is 50, and the clear point number is 100.

The image of the mini game in FIG. 16 will be described here. FIG. 16 shows the situation where the cards 81 and 84 are held among the cards 81 to 85 displayed in FIG. 15.

The image of the mini game in FIG. 17 will be described here. FIG. 17 shows the situation where the cards other than the hold cards 81 and 84 are replaced, and the combination of the five displayed cards is a combination of “four-of-a-kind” as a poker role. The representation of “40 POINTS GET!!” indicates that the accumulative point number is updated to 90 by getting 40 points being the point number corresponding to the four-of-a-kind.

Thus, a hold operation enables the player to achieve a higher poker role to get a higher point number. Consequently, the player's hold operation can increase the possibility that a higher number of times of the free game will be decided. This further enhances entertainment properties.

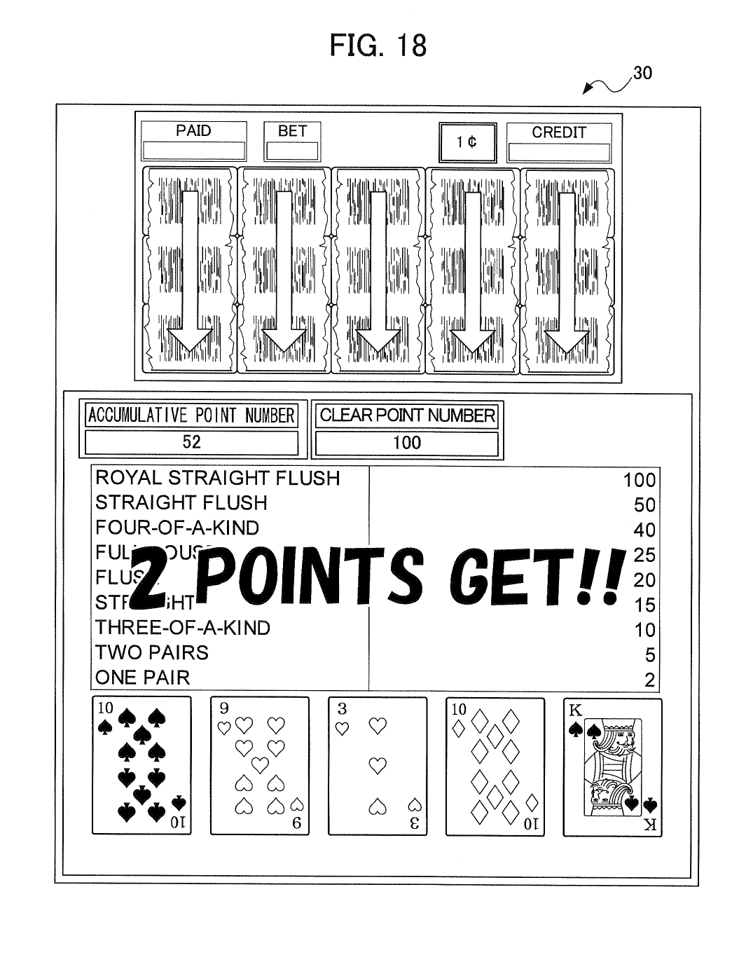

The image of the mini mage in FIG. 18 will be described here. FIG. 18 shows the situation where none of the cards 81 to 85 displayed in FIG. 15 have been held. This situation further includes that the combination of the five displayed cards is a combination of “one pair” as a poker role. The representation of “2 POINTS GET!!” indicates that the accumulative point number is updated to 52 by getting 2 points being the point number corresponding to the one pair.

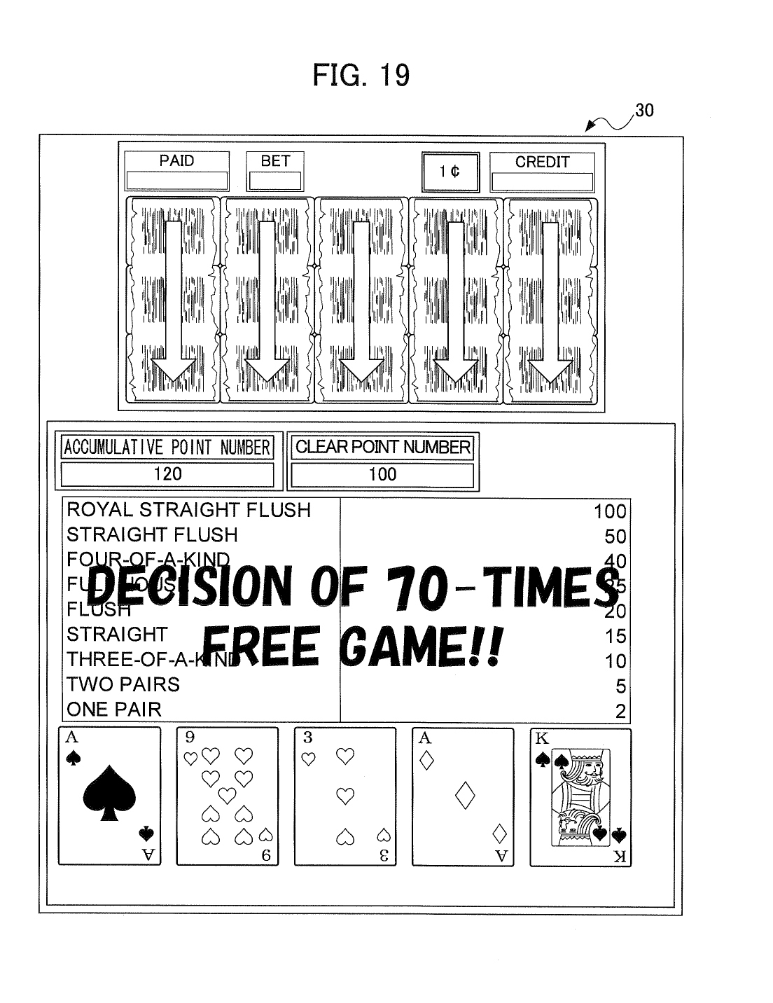

The image of the mini game in FIG. 19 will be described here. FIG. 19 shows the situation where the accumulative point is 120 when the mini game is terminated, and the accumulative point number is greater than the clear point number. The representation of “Decision of 70-times free game!!” indicates that the number of times of the free game is decided to be 70. This image of the mini game can be displayed in response to the case where the number of times of the free game is decided to be 70 in the free game number decision processing (step S33 in FIG. 9B).

While the embodiment of the gaming machine according to the present invention has been described, it is to be understood that the above description is intended to be illustrative, and not restrictive, and any changes in design may be made to specific configurations such as various means. It is also to be understood that the effects described in the foregoing embodiment are intended to be illustrative as an optimum effect that the present invention can produce, and the effects according to the present invention is not limited to that described in the foregoing embodiment.

For example, although in the foregoing embodiment, the images of the free game and the images of the mini game are displayed in the upper display area and the lower display area in the display area of the liquid crystal display 30, respectively, the images of the mini game may be displayed in the upper display area, and the images of the free game may be display in the lower display area. Alternatively, the images of the mini game may be displayed on the liquid crystal display 40.

Although in the foregoing embodiment, the accumulative point number is not updated unless the poker role is achieved, without limitation, the update may be performed so as to decrement the accumulative point number.

Although in the foregoing embodiment, the player can hold the cards once, without limitation, holding two times or more may be permitted.

Although in the foregoing embodiment, the mini game can be performed only provided that the basic game has commenced, without limitation, the mini game may be executed every time the basic game is executed.

If a predetermined condition is achieved (for example, if a symbol combination of “HOLY CUP” is achieved), the mini game may be executed by making a transition of the game state to a special game state such as a mini game mode.

While preferred embodiments of the present invention have been described and illustrated above, it is to be understood that they are exemplary of the invention and are not to be considered to be limiting. Additions, omissions, substitutions, and other modifications can be made thereto without departing from the spirit or scope of the present invention. Accordingly, the invention is not to be considered to be limited by the foregoing description and is only limited by the scope of the appended claims.

What is claimed is:

1. A gaming machine comprising:
a display for displaying an image;
memory for storing an accumulative point number to be updated depending on an outcome of a mini game, and a plurality of types of point numbers corresponding to a plurality of types of card image combinations, respectively;
a first input device for outputting card image identification data identifying a card image a player selects from a plurality of card images displayed on the display;
a second input device for outputting a signal that starts a basic game; and
a controller operable to:
(a) start the basic game in response to a receipt of the signal from the second input device;
(b) execute the mini game provided that the basic game has commenced;
(c) display on the display a predetermined number of card images every time the mini game is executed;
(d) if the card image identification data are received before an elapse of a predetermined time from a start of execution of the mini game, perform processing to display the received card image, depending on the received card image identification data, by replacing the displayed predetermined number of card images;
(e) unless the card image identification data are received before the elapse of the predetermined time, display intactly the displayed predetermined number of card images;
(f) decide whether to update the accumulative point number, depending on a combination of the displayed card images;
(g) if a decision is made to update, update the accumulative point number by adding a point number based on the combination to the accumulative point number;
(h) decide a number of times of a free game, depending on an accumulative point number updated after the mini game is executed a predetermined number of times; and
(i) provided that a predetermined condition is met, make a transition from the basic game to the free game, and execute the free game by the decided number of times.

2. A gaming machine comprising:
a display for displaying an image;
memory for storing an accumulative point number to be updated depending on an outcome of a mini game, and a plurality of types of point numbers corresponding to a plurality of types of card image combinations, respectively;
a first input device for outputting card image identification data identifying a card image a player selects from a plurality of card images displayed on the display;
a second input device for outputting a signal that starts a basic game; and
a controller operable to:
(a) start the basic game in response to a receipt of the signal from the second input device;
(b) execute the mini game provided that the basic game has commenced;
(c) display on the display a predetermined number of card images every time the mini game is executed;
(d) if the card image identification data are received before an elapse of a predetermined time from a start of execution of the mini game, perform processing to display the received card image, depending on the received card image identification data, by replacing the displayed predetermined number of card images;
(e) unless the card image identification data are received before the elapse of the predetermined time, display intactly the displayed predetermined number of card images;
(f) decide whether to update the accumulative point number, depending on a combination of the displayed card images;
(g) if a decision is made to update, update the accumulative point number by adding a point number based on the combination to the accumulative point number;
(h) display the updated accumulative point number;
(i) decide a number of times of a free game, depending on an accumulative point number updated after the mini game is executed a predetermined number of times; and
(j) provided that a predetermined condition is met, make a transition from the basic game to the free game, and execute the free game by the decided number of times.

3. A gaming machine comprising:
a display for displaying an image;
memory for storing an accumulative point number to be updated depending on an outcome of a mini game, and a plurality of types of point numbers corresponding to a plurality of types of card image combinations, respectively;
a first input device for outputting card image identification data identifying a card image a player selects from a plurality of card images displayed on the display;
a second input device for outputting a signal that starts a basic game; and
a controller operable to:
(a) start the basic game in response to a receipt of the signal from the second input device;
(b) execute the mini game provided that the basic game has commenced;
(c) display on the display a predetermined number of card images every time the mini game is executed;
(d) if the card image identification data are received before an elapse of a predetermined time from a start of execution of the mini game, perform processing to display the received card image, depending on the received card image identification data, by replacing the displayed predetermined number of card images;
(e) unless the card image identification data are received before the elapse of the predetermined time, display intactly the displayed predetermined number of card images;
(f) decide whether to update the accumulative point number, depending on a combination of the displayed card images;
(g) if a decision is made to update, update the accumulative point number by adding a point number based on the combination to the accumulative point number;
(h) display the updated accumulative point number and a predetermined clear point number;
(i) if an accumulative point number updated after the mini game is executed a predetermined number of times is at least the predetermined clear point number, decide a number of times of a free game, depending on the updated accumulative point number; and
(j) provided that a predetermined condition is met, make a transition from the basic game to the free game, and execute the free game by the decided number of times.

4. A gaming machine comprising:
a display for displaying an image;
memory for storing an accumulative point number to be updated depending on an outcome of a mini game, and a plurality of types of point numbers corresponding to a plurality of types of card image combinations, respectively;
a first input device for outputting card image identification data identifying a card image a player selects from a plurality of card images displayed on the display;
a second input device for outputting a signal that starts a basic game; and
a controller operable to:
(a) start the basic game in response to a receipt of the signal from the second input device;
(b) execute the mini game provided that the basic game has commenced;
(c) display on the display a predetermined number of card images every time the mini game is executed;
(d) if the card image identification data are received before an elapse of a predetermined time from a start of execution of the mini game, perform processing to display the received card image, depending on the received card image identification data, by replacing the displayed predetermined number of card images;
(e) unless the card image identification data are received before the elapse of the predetermined time, display intactly the displayed predetermined number of card images;
(f) decide whether to update the accumulative point number, depending on a combination of the displayed card images;
(g) if a decision is made to update, update the accumulative point number by adding a point number based on the combination to the accumulative point number;
(h) display the updated accumulative point number and a predetermined clear point number;
(i) if an accumulative point number updated after the mini game is executed a predetermined number of times is at least the predetermined clear point number, decide a number of times of a free game, depending on the updated accumulative point number and the predetermined clear point number; and
(j) provided that a predetermined condition is met, make a transition from the basic game to the free game, and execute the free game by the decided number of times.

5. A gaming machine comprising:
a display for displaying an image;
memory for storing an accumulative point number to be updated depending on an outcome of a mini game, and a plurality of types of point numbers corresponding to a plurality of types of card image combinations, respectively;
a first input device for outputting card image identification data identifying a card image a player selects from a plurality of card images displayed on the display;
a second input device for outputting a signal that starts a basic game; and
a controller operable to:
(a) start the basic game in response to a receipt of the signal from the second input device;
(b) provided that the basic game has commenced, execute the mini game every time the basic game is executed;
(c) display on the display a predetermined number of card images every time the mini game is executed;
(d) if the card image identification data are received before an elapse of a predetermined time from a start of execution of the mini game, perform processing to display the received card image, depending on the received card image identification data, by replacing the displayed predetermined number of card images;
(e) unless the card image identification data are received before the elapse of the predetermined time, display intactly the displayed predetermined number of card images;
(f) decide whether to update the accumulative point number, depending on a combination of the displayed card images;
(g) if a decision is made to update, update the accumulative point number by adding a point number based on the combination to the accumulative point number;
(h) decide a number of times of a free game, depending on an accumulative point number updated after the mini game is executed a predetermined number of times; and
(i) provided that a predetermined condition is met, make a transition from the basic game to the free game, and execute the free game by the decided number of times.

6. A gaming machine comprising:
a display for displaying an image;
memory for storing an accumulative point number to be updated depending on an outcome of a mini game, and a plurality of types of point numbers corresponding to a plurality of types of card image combinations, respectively;
a first input device for outputting card image identification data identifying a card image a player selects from a plurality of card images displayed on the display;
a second input device for outputting a signal that starts a basic game; and
a controller operable to:
(a) start the basic game in response to a receipt of the signal from the second input device;
(b) provided that the basic game has commenced, execute the mini game every time the basic game is executed;
(c) display on the display a predetermined number of card images every time the mini game is executed;
(d) if the card image identification data are received before an elapse of a predetermined time from a start of execution of the mini game, perform processing to display the received card image, depending on the received card image identification data, by replacing the displayed predetermined number of card images;
(e) unless the card image identification data are received before the elapse of the predetermined time, display intactly the displayed predetermined number of card images;
(f) decide whether to update the accumulative point number, depending on a combination of the displayed card images;
(g) if a decision is made to update, update the accumulative point number by adding a point number based on the combination to the accumulative point number;
(h) display the updated accumulative point number;
(i) decide a number of times of a free game, depending on an accumulative point number updated after the mini game is executed a predetermined number of times; and
(j) provided that a predetermined condition is met, make a transition from the basic game to the free game, and execute the free game by the decided number of times.

7. A gaming machine comprising:
a display for displaying an image;
memory for storing an accumulative point number to be updated depending on an outcome of a mini game, and a plurality of types of point numbers corresponding to a plurality of types of card image combinations, respectively;
a first input device for outputting card image identification data identifying a card image a player selects from a plurality of card images displayed on the display;
a second input device for outputting a signal that starts a basic game; and
a controller operable to:
(a) start the basic game in response to a receipt of the signal from the second input device;
(b) provided that the basic game has commenced, execute the mini game every time the basic game is executed;
(c) display on the display a predetermined number of card images every time the mini game is executed;
(d) if the card image identification data are received before an elapse of a predetermined time from a start of execution of the mini game, perform processing to display the received card image, depending on the received card image identification data, by replacing the displayed predetermined number of card images;
(e) unless the card image identification data are received before the elapse of the predetermined time, display intactly the displayed predetermined number of card images;
(f) decide whether to update the accumulative point number, depending on a combination of the displayed card images;
(g) if a decision is made to update, update the accumulative point number by adding a point number based on the combination to the accumulative point number;
(h) display the updated accumulative point number and a predetermined clear point number;
(i) if an accumulative point number updated after the mini game is executed a predetermined number of times is at least the predetermined clear point number, decide a number of times of a free game, depending on the updated accumulative point number; and
(j) provided that a predetermined condition is met, make a transition from the basic game to the free game, and execute the free game by the decided number of times.

8. A gaming machine comprising:
a display for displaying an image;
memory for storing an accumulative point number to be updated depending on an outcome of a mini game, and a plurality of types of point numbers corresponding to a plurality of types of card image combinations, respectively;
a first input device for outputting card image identification data identifying a card image a player selects from a plurality of card images displayed on the display;
a second input device for outputting a signal that starts a basic game; and
a controller operable to:
(a) start the basic game in response to a receipt of the signal from the second input device;
(b) provided that the basic game has commenced, execute the mini game every time the basic game is executed;
(c) display on the display a predetermined number of card images every time the mini game is executed;
(d) if the card image identification data are received before an elapse of a predetermined time from a start of execution of the mini game, perform processing to display the received card image, depending on the received card image identification data, by replacing the displayed predetermined number of card images;
(e) unless the card image identification data are received before the elapse of the predetermined time, display intactly the displayed predetermined number of card images;
(f) decide whether to update the accumulative point number, depending on a combination of the displayed card images;
(g) if a decision is made to update, update the accumulative point number by adding a point number based on the combination to the accumulative point number;
(h) display the updated accumulative point number and a predetermined clear point number;
(i) if an accumulative point number updated after the mini game is executed a predetermined number of times is at least the predetermined clear point number, decide a number of times of a free game, depending on the updated accumulative point number and the predetermined clear point number; and
(j) provided that a predetermined condition is met, make a transition from the basic game to the free game, and execute the free game by the decided number of times.

9. A gaming machine comprising:
a display for displaying an image;
memory for storing an accumulative point number to be updated depending on an outcome of a mini game, and a plurality of types of point numbers corresponding to a plurality of types of card image combinations, respectively;
a first input device for outputting card image identification data identifying a card image a player selects from a plurality of card images displayed on the display;
a second input device for outputting a signal that starts a basic game; and
a controller operable to:
(a) start the basic game in response to a receipt of the signal from the second input device;
(b) provided that a predetermined condition is met, make a transition to a special game state where the mini game is repetitively executed a predetermined number of times;
(c) execute the mini game upon completion of the transition to the special game state;
(d) display on the display a predetermined number of card images every time the mini game is executed;
(e) if the card image identification data are received before an elapse of a predetermined time from a start of execution of the mini game, perform processing to display the received card image, depending on the received card image identification data, by replacing the displayed predetermined number of card images;
(f) unless the card image identification data are received before the elapse of the predetermined time, display intactly the displayed predetermined number of card images;
(g) decide whether to update the accumulative point number, depending on a combination of the displayed card images;
(h) if a decision is made to update, update the accumulative point number by adding a point number based on the combination to the accumulative point number;
(i) decide a number of times of a free game, depending on an accumulative point number updated after the mini game is executed a predetermined number of times; and
(j) provided that a different condition from the predetermined condition is met, make a transition from the basic game to the free game, and execute the free game by the decided number of times.

10. A gaming machine comprising:
a display for displaying an image;
memory for storing an accumulative point number to be updated depending on an outcome of a mini game, and a plurality of types of point numbers corresponding to a plurality of types of card image combinations, respectively;
a first input device for outputting card image identification data identifying a card image a player selects from a plurality of card images displayed on the display;
a second input device for outputting a signal that starts a basic game; and
a controller operable to:
(a) start the basic game in response to a receipt of the signal from the second input device;
(b) provided that a predetermined condition is met, make a transition to a special game state where the mini game is repetitively executed a predetermined number of times;
(c) execute the mini game upon completion of the transition to the special game state;
(d) display on the display a predetermined number of card images every time the mini game is executed;
(e) if the card image identification data are received before an elapse of a predetermined time from a start of execution of the mini game, perform processing to display the received card image, depending on the received card image identification data, by replacing the displayed predetermined number of card images;
(f) unless the card image identification data are received before the elapse of the predetermined time, display intactly the displayed predetermined number of card images;
(g) decide whether to update the accumulative point number, depending on a combination of the displayed card images;
(h) if a decision is made to update, update the accumulative point number by adding a point number based on the combination to the accumulative point number;
(i) display the updated accumulative point number;
(j) decide a number of times of a free game, depending on an accumulative point number updated after the mini game is executed a predetermined number of times; and
(k) provided that a different condition from the predetermined condition is met, make a transition from the basic game to the free game, and execute the free game by the decided number of times.

11. A gaming machine comprising:
a display for displaying an image;
memory for storing an accumulative point number to be updated depending on an outcome of a mini game, and a plurality of types of point numbers corresponding to a plurality of types of card image combinations, respectively;
a first input device for outputting card image identification data identifying a card image a player selects from a plurality of card images displayed on the display;
a second input device for outputting a signal that starts a basic game; and
a controller operable to:
(a) start the basic game in response to a receipt of the signal from the second input device;
(b) provided that a predetermined condition is met, make a transition to a special game state where the mini game is repetitively executed a predetermined number of times;
(c) execute the mini game upon completion of the transition to the special game state;
(d) display on the display a predetermined number of card images every time the mini game is executed;
(e) if the card image identification data are received before an elapse of a predetermined time from a start of execution of the mini game, perform processing to display the received card image, depending on the received card image identification data, by replacing the displayed predetermined number of card images;
(f) unless the card image identification data are received before the elapse of the predetermined time, display intactly the displayed predetermined number of card images;
(g) decide whether to update the accumulative point number, depending on a combination of the displayed card images;
(h) if a decision is made to update, update the accumulative point number by adding a point number based on the combination to the accumulative point number;
(i) display the updated accumulative point number and a predetermined clear point number;
(j) if an accumulative point number updated after the mini game is executed a predetermined number of times is at least the predetermined clear point number, decide a number of times of a free game, depending on the updated accumulative point number; and
(k) provided that a different condition from the predetermined condition is met, make a transition from the basic game to the free game, and execute the free game by the decided number of times.

12. A gaming machine comprising:
a display for displaying an image;
memory for storing an accumulative point number to be updated depending on an outcome of a mini game, and a plurality of types of point numbers corresponding to a plurality of types of card image combinations, respectively;
a first input device for outputting card image identification data identifying a card image a player selects from a plurality of card images displayed on the display;
a second input device for outputting a signal that starts a basic game; and
a controller operable to:
(a) start the basic game in response to a receipt of the signal from the second input device;
(b) provided that a predetermined condition is met, make a transition to a special game state where the mini game is repetitively executed a predetermined number of times;
(c) execute the mini game upon completion of the transition to the special game state;
(d) display on the display a predetermined number of card images every time the mini game is executed;
(e) if the card image identification data are received before an elapse of a predetermined time from a start of execution of the mini game, perform processing to display the received card image, depending on the received card image identification data, by replacing the displayed predetermined number of card images;
(f) unless the card image identification data are received before the elapse of the predetermined time, display intactly the displayed predetermined number of card images;
(g) decide whether to update the accumulative point number, depending on a combination of the displayed card images;
(h) if a decision is made to update, update the accumulative point number by adding a point number based on the combination to the accumulative point number;
(i) display the updated accumulative point number and a predetermined clear point number;
(j) if an accumulative point number updated after the mini game is executed a predetermined number of times is at least the predetermined clear point number, decide a number of times of a free game, depending on the updated accumulative point number and the predetermined clear point number; and
(k) provided that a different condition from the predetermined condition is met, make a transition from the basic game to the free game, and execute the free game by the decided number of times.
